(19) United States
(12) Patent Application Publication
(10) Pub. No.: US 2015/0004923 A1
(43) Pub. Date: Jan. 1, 2015

(54) APPARATUS, SYSTEM AND METHOD FOR PERFORMING PEAK POWER REDUCTION OF A COMMUNICATION SIGNAL

(71) Applicant: Steve Andre Beaudin, Ottawa (CA)

(72) Inventor: Steve Andre Beaudin, Ottawa (CA)

(21) Appl. No.: 14/377,652

(22) PCT Filed: Feb. 25, 2013
(86) PCT No.: PCT/CA2013/000154

§ 371 Date: Aug. 8, 2014

Related U.S. Application Data
(60) Provisional application No. 61/603,235, filed on Feb. 25, 2012.

(51) Int. Cl. H04B 1/04

(52) U.S. Cl. CPC H04B 1/04; H04B 2001/0416
USPC 455/127.2

(57) ABSTRACT

A method, system and apparatus are provided for effecting peak power reduction of a communication signal. In particular, the method achieves peak power reduction by generating an out of band peak power reduction (OBPPR) signal; which reduces the peaks of the waveform. The OBPPR signal can be generated at baseband, IF or RF. The method can be implemented in the digital domain using FPGA, DSP or ASIC or can be implemented in the analog domain using discrete circuitry, RFIC's or MMIC's or multi-chip modules. The method does not introduce significant amounts of EVM or sacrifice any capacity and as such offers considerable advantages compared to current state of the art methods. Furthermore, the method can be combined and is approximately additive with existing power reduction methods to effect greater levels of peak power reduction. The inventor has demonstrated a system which takes an OFDM waveform with a PAPR of 7.16 dB as an input, and produces an output waveform with a PAPR of 4.5 dB, while introducing very negligible amounts of EVM. The inventor has also demonstrated a two carrier OFDM transmitter as well as a Multi-Carrier GSM transmitter with 8 carriers, where the OBPPR signal was able to reduce the peak to average power ratio of the waveform from 9 dB to 2.8 dB and from 9.5 dB to 4.2 dB respectively.

### CROSS REFERENCE TO RELATED APPLICATIONS

U.S. Provisional Patent 61/603,235

### TECHNICAL FIELDS

The present invention generally relates to signal processing, and particularly relates to reducing the peak-to-average ratio (PAR) of communications signals, such as communication signals for transmission in a wireless communication network, TV broadcast systems, Point to Point wireless communications, satellite links and microwave radio. In general terms, the present invention can be applied to any communication signal where it is desirable to reduce the peak to average power ratio.

### BACKGROUND

Standards for many communication techniques like cellular, Wireless Local Area Network (WLAN), digital TV broadcast, Asymmetric Digital Subscriber Line (ADSL), WiMax, LTE, LTE-Advanced etc. use signal modulation techniques based on both amplitude and phase modulation. In comparison to pure phase (or frequency) modulation, amplitude-modulated signals require linear amplification for accurate signal reproduction. Nonlinearity in the amplification of such signals introduces significant problems, such as increased adjacent channel interference (ACI) and increases the error-vector-magnitude (EVM) for the signal itself. Increased EVM limits the modulation order than can reliably be employed and hence the achievable spectral efficiency of the communication channel.

Linear amplification presents challenges, particularly in the cost and power limited environments typical found in wireless communication applications. For example, accommodating larger signal amplitude variations in a linear transmitter generally causes reduced power efficiency and/or higher circuit cost and complexity. In order to achieve increased levels of spectral efficiency, the current trend is to use modulation schemes that exhibit very large amplitude variations. For example, the introduction of HSDPA (High Speed Downlink Packet Access) and HSUPA (High Speed Uplink Packet Access) within the 3GPP standard have significantly increased transmit signal amplitude variations. The LTE standard uses 64 QAM modulations and may employ even higher order modulations as the standard evolves towards LTE-advanced. Some point to point communications systems currently use 256QAM or even modulations as high as 512 QAM and there is research work which aims at making modulations as high as 1024 QAM practical. Additionally, many standards such as WiMax, LTE, WLAN, digital TV broadcast, ADSL, etc., are based on Orthogonal Frequency Division Multiplex (OFDM) modulation techniques that are known to have a very large amplitude variation. Hence the trend to use modulation schemes with large amplitude variations coupled with the need to maintain a very low EVM make linear amplification and peak power reduction techniques of significant commercial interest.

For an LTE waveform, the peak to average power ratio can typically be on the order of 10 dB without peak power reduction algorithms and can be reduced to about 7 dB using state of the art peak power reduction algorithms. Dropping the peak to average power ratio typically comes at the expense of increased EVM and hence the achievable peak power reduction is limited by the desire to use higher order modulations. For an LTE base station where we desire to have a maximum average output power of 50 Watts, a peak to average power ratio of 7 dB would require that the Power Amplifiers be sized to accommodate peak instantaneous powers as high as 250 Watts. Accommodating a large peak power while maintaining a high power added efficiency requires complex power amplifier technologies such as Doherty amplifiers which are difficult to linearize. A typical Class AB amplifier which can provide acceptable efficiencies, on the order of 50%, when operating at the it's 1 dB compression point may only provide efficiencies of about 20% when amplifying a signal with a PAPR of 7 dB. The reduced efficiency is due to the fact that to achieve a maximum average power of 50 Watts while accommodating peak powers as high as 250 Watts necessitates the use of a power transistor with a peak power of at least 250 Watts. Doherty amplifiers which are now well known in the wireless industry offer an improved efficiency by employing two power transistors in a combiner network. One device is typically biased in Class AB and always on, while the second device is only turned on when the signal is peaking. As the peaking transistor switches on and off, large amounts of memory and non-linearities are introduced which require advanced linearization methods such as baseband pre-distortion, usually with memory correction. Such techniques are therefore fairly expensive to implement and usually only applicable to base stations. For handsets, Doherty type amplifiers and base band pre-distortion algorithms which are capable of coping with the inherent memory effects of Doherty amplifiers, are typically not used. As such, handsets typically use an unlinearized class AB amplifier.

Reducing the peak to average power ratio of a waveform provides two benefits. The first is that for a given maximum average power, it allows us to decrease the size of the power transistors which provides an immediate cost reduction, even when Doherty amplifiers are used. The second, is that when the peak to average power ratio is reduced, we are able to achieve higher power added efficiencies, especially when class AB amplifiers are used.

One obvious but unsophisticated technique to reduce the amplitude variation is to clip the signal peaks to a certain level. This method is simple but comes at the cost of dramatically increased ACI and EVM. As the signal peaks are clipped, distortion is introduced which creates in-channel distortion as well as energy outside of the channel, which results in an increased EVM and increased level of adjacent channel interference.

Improvements on this method consist of employing digital signal processing methods to clip the signal or compress its peaks using a baseband algorithm and then filtering the clipped signal using a channel select filter to eliminate distortion which falls outside of the channel of interest. Filtering the signal typically causes the peaks to increase beyond the value to which they were clipped or compressed, but to remain lower than the original unclipped signal. As such, this method has been implemented using multiple passes of clip, filter, clip, filter etc. . . . for optimal results. Since the distortion which falls outside of the channel has been filtered, this method does not sacrifise ACI, but still results in substantial EVM increase within the channel.

For OFDM signals one method which has been successfully proposed in standards and implemented in practise is to reserve a sub-set of OFDM tones for the purpose of implementing crest factor reduction. The reserved tones are modulated and the proper voltage and phase applied to each in order to achieve a reduced peak to average power ratio. This method, when used properly does not introduce any ACI or EVM. However, tones which are used for the purposes of peak power reduction cannot be used to carry data and as such the channel capacity is reduced.

A further proposal in the OFDM signal context has been to reduce amplitude variation by directly altering the mapping of the data onto the sub-carriers, such that the overall amplitude variation is lowered. This proposal, however, imposes restrictions on the OFDM signal itself, e.g., by allocating a large fraction of the sub-carriers for reducing amplitude variations, or by introducing a specific coding scheme.

As such, the majority of methods either result in increased EVM of reduced channel capacity. A method which can be used to reduce the peak power of a modulated carrier without increasing the EVM or reducing the capacity of the channel is therefore desirable.

### DISCLOSURE OF INVENTION

The current invention achieves a substantial reduction in peak power without sacrificing EVM or channel capacity or ACI. The invention comprises of injecting a signal outside of the channel or band of interest, for the purposes of reducing the peak power when it is combined with the desired information bearing carrier, prior to its amplification by the power amplifier. Once amplified, the peak power reduction signal is filtered by the RF roofing filter or duplexer. The required amplitude and phase of the Out of Band Peak Power Reducing (OBPPR) Signal can be determined using DSP methods by analysing the desired information bearing signal and determining the amplitude and phase of the necessary out of band peak power reducing OBPPR signal to achieve the desired peak cancellation. Algorithms or digital signal processing circuits or functions can be developed to efficiency produce the Out of Band Peak Power Reducing (OBPPR) Signal. Alternatively, an analog circuit can be developed which can effectively generate an Out of Band Peak Power Reducing (OBPPR) Signal. Using an Out of Band Peak Power Reducing (OBPPR) signal requires that the transceiver has sufficient bandwidth to excite both the desired carrier and the out of band peak power reduction (OBPPR) signal. As of the time of the writing of this patent, Digital to Analog converters have become relatively affordable and are easily available at speeds of up to 1 Giga sample per second (Gsps) with 14 bits of resolution. For a slightly higher price, DAC's as fast as 3.6 Gsps are available which would enable a transceiver with a bandwidth well in excess of 1 GHz.

Conversely, typical RF bands span 75 MHz or less. For example, the downlink band which is typically used for GSM (E-UTRA Operating Band 8) spans from 925 MHz to 960 MHz and is therefore only 35 MHz wide. E-UTRA Operating Band 1, the band used for UMTS deployments in Europe has a downlink from 2110 to 2170 MHz and is therefore only 60 MHz wide. The DCS band, E-UTRA Operating Band 3, is the widest band currently defined below 3 GHz and has a downlink spanning 1805 Mhz to 1880 MHz, and is therefore 75 MHz wide. As such, a transceiver which is capable of exciting a desired information bearing signal in a band of interest while simultaneously exciting an out of band peak power reduction (OBPPR) signal outside of this band can be practically implemented. As such, the composite signal passing through the power amplifier, although spanning a wide bandwidth, has a substantially reduced peak power. This allows the power transistor to be of a smaller size and higher power amplifier efficiencies to be achieved.

Once amplified by the power amplifier, the out of band peak power reducing (OBPPR) signal can be filtered by the RF roofing filter or duplexer, while the information bearing signal passes through the filter and is sent to the antenna. After the power amplifier, the signal path consists of passive devices such as circulators, filters, combiners and the antenna, hence the resultant increase in peak power is not detrimental to the system. The removal of the OBPPR signal allows the signal being radiated from the antenna to occupy only those frequencies of the carriers containing the information bearing signal so that the system can meet all regulatory requirements, while benefiting from a lower Peak Power at the Power Amplifier.

The algorithms and circuits can be used for a single carrier system, a multi-carrier system such as multi-carrier UMTS, multi-carrier CDMA, multi-carrier LTE and even multi-carrier GSM where the carriers are undergoing frequency hopping. In the case of a multi-carrier system there is no required change to the algorithm since we are not generating any noise or distortion within the band of the transmit chain where the information bearing carriers are situated. The system, method and apparatus can also be used for a multiband system where two or more communication signals are being transmitted in different RF bands. For example a multi-band radio could be generated which is capable of transmitting an LTE carrier in the PCS band and AWS band simultaneously, or any other combination of RF bands which is desirable

### BRIEF DESCRIPTION OF DRAWINGS

FIG. 1: Diagram of Transmit Chain showing proposed implementation where the OBPPR signal is being generated in the digital domain.

FIG. 2: Block Diagram of the Digital Signal Processing circuit which reduces the Peak Power of a signal by generating and adding an Out of Band Peak Power Reduction (OBPPR) Signal.

FIG. 3: Diagram showing frequency plan of desired signal, and the Out of Band Peak Power Reduction Signal, at baseband.

FIG. 4: Frequency Plan of various signals once upconverted to the Radio Frequency

FIG. 5: Block Diagram of Transmit Chain showing proposed implementation where the OBPPR signal is being generated in the analog domain at both baseband and RF.

FIG. 6: Frequency Domain plot of original waveform at Baseband

FIG. 7: Time Domain amplitude plot of original baseband waveform.

FIG. 8: Complementary Cumulative Distribution function showing Peak to Average Ratio statistics of Original waveform.

FIG. 9: Time Domain Amplitude plot of peak reduced waveform.

FIG. 10: Frequency Domain Plot of Carrier with OBPPR signal

FIG. 11: Frequency Domain plot of OBPPR signal.

FIG. 12: Complementary Cumulative Distribution Function showing Peak to Average Ratio statistics for the Original and Peak Reduced waveform.

FIG. 13: Time Domain Plot of the Original and Peak Reduced signals at RF.

FIG. 14: Frequency Domain Plot of Peak Reduced Signal at RF

FIG. 15: Frequency Domain Ploat of Peak Reduced Signal after RF OBPPR

FIG. 16: Time domain waveform showing Original, BB-OBPPR waveform and RF-OBPPR waveforms.

FIG. 17: CCDF of Original, Carrier plus BB-OBPPR signal and RF-OBPPR signals.

FIG. 18: RF Frequency Plan showing the OBPPR signal which has been generated by processing the carrier at its RF frequency, as well as the response of the high pass filter which is used to filter the OBPPR signal.

FIG. 19: AM to AM distortion curve of a reference Power Amplifier.

FIG. 20: Distortion introduced by the Power Amplifier, to the original waveform which has not been peak power reduced.

FIG. 21: Distortion introduced by the Power Amplifier, to the Peak Power Reduced Waveform.

FIG. 22: Complementary Cumulative Distribution Function showing Peak to Average Ratio statistics for the Original waveform, waveform which was peak reduced using baseband processing only, waveform which was peak reduced using RF processing only and waveform which was peak reduced using both baseband and RF processing.

FIG. 23: Digital Signal Processing Circuit which can generate the Peak Reduce the waveform at RF.

FIG. 24: Single Stage Analog Peak Power Reducing Circuit

FIG. 25: Multi-Stage Analog Peak Power Reducing Circuit

FIG. 26: Non contiguous 10 MHz Carriers in a 30 MHz Band

FIG. 27: Non contiguous Carriers and OBPPR Signal

FIG. 28: Non contiguous Carriers and OBPPR Signal

FIG. 29: CCDF of Waveforms after each Stage

FIG. 30: 8 GSM Carriers in a 20 MHz Band

FIG. 31: Spectrum of Peak Reduced Waveform

FIG. 32: CCDF of Signals when OBPPR is used alone

FIG. 33: CCDF's when OBPPR is used in conjunction with in Band PPR

FIG. 34: Theoretical Efficiencies of Class AB and Class A Amplifiers with OBPPR

### DETAILED DESCRIPTION OF PREFERRED EMBODIMENT

Systems, Methods and Apparatus according to preferred embodiments of the present invention provide for reducing the peak to average power ratio of a modulated communication signal such as those typically used in communication systems and more specifically wireless communication. Specifically, the present invention achieves a reduction in the peak to average power ratio by adding an out of band peak power reducing (OBPPR) signal.

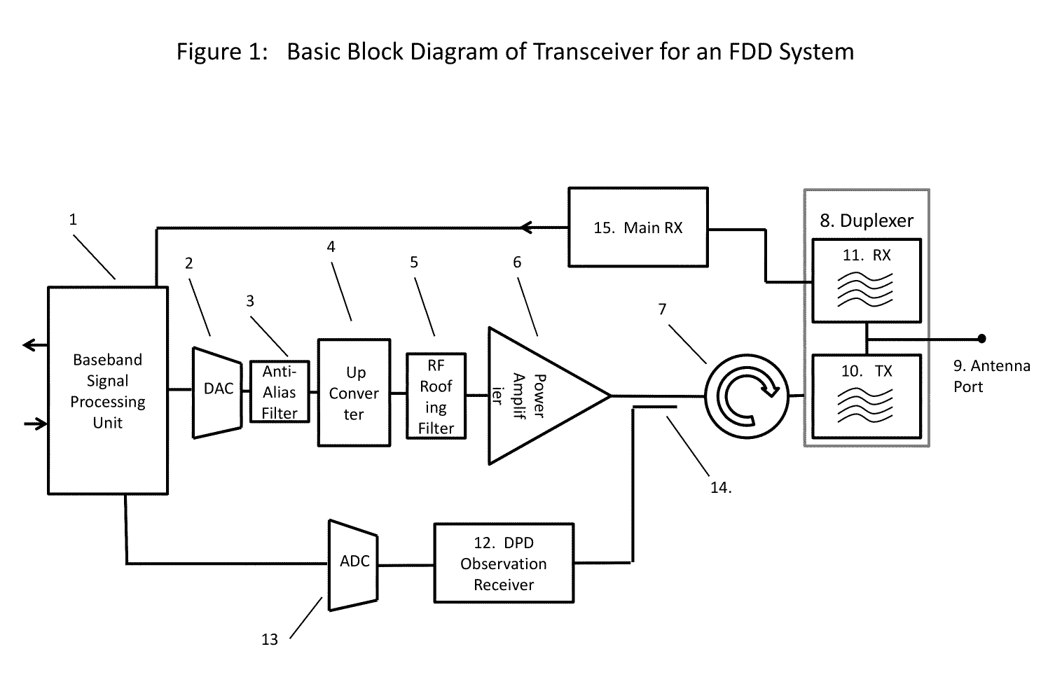

FIG. 1 shows a block diagram of a transmit chain for a base station. The information bearing signal usually originates in the modem of the terminal or base station and is transferred to the Baseband Signal Processing 1 of the transceiver. Typical functions of the Baseband Signal Processing Unit 1 include up-sampling the IQ data, filtering the IQ data to remove out of channel energy, up-converting the digital IQ data to a complex IF or real IF or potentially even digital RF. Peak Power Reduction and Base Band Predistortion algorithms are also functions which are routinely incorporated in the Baseband Signal Processing Unit 1 of a radio. In the preferred implementation of our system, the OBPPR signal would be generated and added to the desired signal within the Baseband Signal Processing Unit 1. Once the digital data has been conditioned, it is sent to a DAC 2, where it is converted into an analog signal. Depending on the implementation of the transmit chain, the DAC could create an analog IQ signal, a complex IF or real IF, or a digital RF signal. In this diagram we are showing a diagram which could either be a Baseband or IF type implementation. The OBPPR signal would be generated by the DAC along with the desired information bearing signal. The third element in the chain is the Anti-Alias filter 3, which is used to remove the alias signals which are created by the DAC. For this system, the anti-alias filter would need to be designed such that the desired information bearing signal as well as the OBPPR signal is permitted to pass through the Anti-Alias Filter 3 while removing the alias signals. In the case of a system implemented using a Baseband or IF DAC, the Up Converter 4 takes the signal and up-converts it to RF. In the case of an analog IQ signal, the Up Converter 4 would also include an IQ Modulator function. In an implementation where an RF DAC is used to generate the RF signal directly, the upconverter would not be needed. Given that we have increased the bandwidth of the signal by adding the OBPPR signal, the Up-converter and or modulator needs to be of sufficient bandwidth to accommodate the increased bandwidth. Most IQ modulators or IF up converters have no difficulty operating over many hundreds of MHz so this is not a major challenge. Once at RF, an RF Roofing Filter 5 would remove unwanted frequency components, such as an image or other spurious, before allowing the signal to reach the Power Amplifier 6. This filter would need to be carefully designed to allow the desired information bearing signal, as well as the added OBPPR signal to pass, and the pass band of this filter would need to be increased beyond the typical RF band. For transmit chains which incorporate baseband pre-distortion this filter is already quite wide to accommodate the pre-distortion sidebands, which can occupy a bandwidth as much as 5 to 7× the bandwidth of the desired signal. The Power Amplifier 6 will typically take the signal from a few mWatts and increase to powers in the range of 50 to a 100 Watts for a macro-cellular base station and is usually the most expensive component in the transmit chain. For a terminal, the output of the Power Amplifier is typically in the range of 0.2 Watts to as high as 2 Watts. For this implementation, the PA would need to amplify the desired information bearing signal as well as the OBPPR signal. As a result of the addition of the OBPPR signal, the composite signal occupies a wider bandwidth but the peaks of the signal are lower so the size of the power devices can be reduced. The Circulator 7, provides some isolation between the TX filter 10, of the Duplexer 8, and the output of the Power Amplifier 6 and absorbs reflection from the TX port of the Duplexer 8. Finally, the TX filter in the Duplexer 8 allows the desired information bearing signal to pass, while rejecting unwanted signals outside of the RF band of interest. Given that the OBPPR signal is outside of the pass band of the RF TX filter 10, this signal would be rejected by the TX Filter in the Duplexer 8. Most of the energy from the OBPPR will reflect from the TX port of the Duplexer 8 and be absorbed by the circulator 7. Once the OBPPR signal has been filtered, the information bearing signal continues towards the antenna port 9 and is eventually radiated. Given that the OBPPR signal has been removed, the peak to average power of the signal increases back towards its original value, but given that the filter and antenna are passive linear devices, there is no significant impact to system performance or cost.

Many high power transmitters now use Adaptive Digital Pre-Distortion to linearize the power amplifier. In FIG. 1 we show the Digital Pre-Distortion (DPD) Observation Receiver 12. This receiver is used to observe the output of the power amplifier. A Directional Coupler 14 is used to sample the forward wave coming out of the Power Amplifier, which is sent to the DPD observation receiver 12 after which it is digitized by the ADC 13. In the Baseband Processing Unit 1, a DPD algorithm would typically compare the out-going waveform with the signal coming out of the PA, and applying the appropriate amounts of pre-distortion to have the desired, distortion free signal at the output of the PA. In cases where a Peak Power Reduction Algorithm operate along side with an DPD Algorithm, the PPR algorithms operate on the waveform first, and the peak reduced waveform is supplied as the reference, desired, waveform to the DPD algorithm.

Also shown in the diagram is the Main Receiver 15. The main receiver is used to amplify, down convert, filter and digitize the received communication signal, which would be the Up Link signal for a base station, or the down link signal for a user terminal

FIG. 2 shows a sample block diagram to generate the OBPPR signal in Digital Signal Processing Unit 1, of the radio. The IQ Data is received from the modem at 33. Typically the modem processes data using a digital sample rate which is only slightly greater than the Nyquist rate of the information bearing signal, to preserve resources. For example, in the LTE standard, for a modulated carrier occupying 10 MHz of bandwidth, the modem processes the signal at a sample rate of 15.36 Msps. Similarly, for a modulated carrier occupying 20 MHz of bandwidth, the modem processes the signal at a sample rate of 30.72 Msps. As such, one of the first functions in the radio is to increase the bandwidth of the digital data using an Up Sampler 21. The Up Sampler can be implemented in many ways which are known in the art. For the purposes of this preferred embodiment, we have chosen to process the carrier at a baseband frequency, but the OBPPR signal can also be generated at an IF or RF frequency if sufficiently high sample rates are used. The next function is block 40, PPR Stage 1. The function of this block is to create the OBPPR signal and incorporate the signal back into the original waveform. The OBPPR signal is generated by first injecting a peak cancellation signal or pulse at “Optional Out of band Signal Injector 22”. The peak cancellation signal should preferably occupy a frequency which is away from the band of interest, and be generated to reduce the peaks of the carrier while adding relatively small amounts of power to the total signal. Injecting a peak cancellation signal using element 22 is optional. Slightly better results have been obtained by using this approach, but large amounts of peak power reduction can nevertheless be achieved without it. Second, the digital waveform is clipped using Clipping Function 23, and then a Subtraction Block 33 subtracts the clipped waveform B from the original waveform A to determine the difference between the clipped and original waveform (C=A−B). Next, the difference waveform C is filtered by a band reject filter which rejects any frequency components which fall at frequencies around the original carrier of the desired information bearing signal. Ideally, the band reject filter would have a rejection band which is as wide or wider than the RF band in which the radio will operate. Preferably, the band reject filter should have a rejection band which is at least as wide as the bandwidth of the RF TX Filter 10. This is to ensure that the frequency components of the OBPPR signal which are amplified by the power amplifier are not permitted to propagate to the antenna and cause interference with other systems operating at those frequencies. In the case of a baseband design, the band reject filter can take the form of a high pass filter. If we are processing the data at an IF then the band reject filter will be a true band reject filter with two passbands on either side of the rejection band. In a parallel signal path, the original data is passed through an All Pass Filter 25 which is designed to have the same delay as the Clipping Function 23 and Band Reject Filter 24. It is important that the two paths have identical delay so that when we subtract the OBPPR signal from the Original waveform at Subtraction Block 26, that the two waveforms, E and D originate from the same samples. The All Pass Filter 25 could potentially be a pass band filter for PPR Stage 1, 40, since the first stage does not have an OBPPR signal. For subsequent stages, the All Pass filter 25 should be wide enough to allow the information bearing signal, as well as the OBPPR signal generated during previous PPR stages, to pass. The subtraction Block 26 performs the operation F=D−E. At the output of PPR Stage 1 Block 40, we have a signal, F, which comprises the original carrier, and the OBPPR signal which is concentrated at a frequency away from the information bearing signal, such that this signal can be filtered by the RF filter after the composite signal (out of band peak reducing signal and information bearing signal) has been amplified by the Power Amplifier. The composite signal has an envelop with reduced peaks compared to the initial information bearing signal. If the Band Reject filter or High pass filter 24 was of sufficient width and had sufficient rejection (>40 dB), very negligible amounts of EVM have been added to the original signal since any clipping energy which was present at frequencies of the original carrier were attenuated by the Band Reject Filter 24. By adding taps to Band Reject Filter 24, the rejection can be increased sufficiently that essentially there is no meaningful contribution to the EVM of the information bearing signal. Greater Peak Power Reduction can be achieved by using a multi-pass approach. Element 41, PPR Stage 2 receives the signal which had been peak power reduced by element 40, PPR Stage 1, and repeats the process. An out of band peak cancellation signal can once again be added to further reduce the remaining peaks. The waveform is once again clipped and passed through a band reject or high pass filter 24 to remove any clipping energy which falls within the desired modulated signal or vicinity. The input signal is then passed through an all pass filter to equalize the delay with the clipped and filtered signal. After this, the additional OBPPR signal is incorporated to the composite signal which was generated in the previous stage, to further reduce the peaks. This process can be repeated many times, and is only limited by the amount of DSP resources and potentially the signal delay that seems acceptable to achieve incremental peak power reduction. The values in the Clipping Function 13 of each PPR Stage can be different. In some cases it may be beneficial to incrementally increase the amount of clipping with each subsequent stage or in others it may be beneficial to clip very aggressively in the first stage, and then clip more lightly in the final stages. The clipping function itself can be any type of function which reduces the peaks of a time domain waveform. Some examples which are well known include hard clipping by preventing the waveform from exceeding a maximum value, or multiplying the incoming waveform by a polynomial to compress the peaks. Using a limiting amplifier type approach where the waveform is amplified by some gain, until the signal amplitude reaches a maximum value after which the level is limited to the desired threshold is an alternative approach. Limiting amplifiers are typically used to square a waveform. For this application, clipping functions which tend to create more energy at large offsets frequencies from the carrier seem to yield better results.

The clipping algorithm can be implemented in an ASIC or an FPGA or can even be implemented in a powerful microprocessor used for DSP. The data can be processed sequentially or it can be processed in batches as is the case with an FFT.

The Filter 24 can be a Band Reject Filter or a High Pass Filter. The purpose of this filter is to remove the information bearing signal as well as distortion products which fall around the information bearing signal to obtain an OBPPR signal which does not add any noise or distortion to the information bearing signal. For IF processing, the filter should be a Band Reject Filter since the OBPPR signal will occupy frequencies on either size of the IF. For Baseband Processing a high pass filter should be used since the OBPPR signal will occupy frequencies above the information bearing signal, for both the I and Q. After the upconversion/modulation then the OBPPR signal will be on either side of the carrier. For RF processing, the filter can either be a High Pass filter or Band Reject Filter. A high pass filter will allow the OBPPR signal to form at the odd harmonics of the RF carrier. A Band Reject Filter will allow the OBPPR signal to form on either side of the RF carrier (intermodulation components) and at the odd harmonics of the RF carrier (harmonic content). The most computationally efficient method is to generate the (intermodulation components) at baseband and to generate the harmonic components at RF using a easily implemented high pass filter, which requires much fewer taps than a band reject filter at RF.

The generation of the OBPPR signal can also be understood by considering the following steps which describe PPR Stage 1 (40) of FIG. 2:
a) Adding an Out of Band Signal such as a pulse “Peak Cancellation Pulse”, which is in anti-phase with the peaks of the communication signal. Given that the center frequency of the pulse does not coincide with the center frequency of the communication signal, the coherence time of the two signals is very short, and the pulse can only cancel out a peak for a very short time period, which is inversely proportional to the frequency offset of the two signals. This step is optional and in some situations including this step results in a lower Peak to Average Power ratio's.
b) Clipping or compressing the communication signal (A) to create a “distorted communication signal” with a reduced peak to average power ratio (B). If this step is performed at baseband, the “distorted communication signal” will no include large amounts of Inter-modulation products of the communication signal. If this step is performed at RF, the “distorted communication signal” will include both the intermodulation products of the communication signal as well as the odd harmonics of the communication signal.
c) Subtracting the original communication signal (A) from the said “distorted communication signal” (B) to arrive at a “distortion signal” (C). The purpose of this step is to isolate only the portion of the signal which was generated by the clipping function “the distortion signal”.
d) Filtering the said “distortion signal” (C) using a Band Reject Filter or High Pass Filter to produce an Out of Band Peak Power Reducing signal (E) with little energy at frequencies which coincide with the communication signal. This step is necessary to remove or suppress any portion of the distortion signal which call at frequencies which coincide or are too near the communication signal. This step prevents or reduces any in band distortion and an increase in EVM.
e) Combining the communication signal (A) with the said Out of Band Peak Power Reducing signal (E), with the appropriate phase, to arrive at a Composite Signal with a Reduced Peak to Average Power Ratio (F).
f) This step can be repeated as many times as necessary. The Composite Signal which exited the previous PPR Stage, for example Composite Signal (F), is now the signal which the algorithm or circuit acts upon to arive at a Second Composite Signal, for example Composite Signal (K), with a reduced peak to average power ratio.

A mathematical function could be developed which performs a similar function to the block diagrams shown in FIG. 2. For example, the simulations provided here were performed in Matlab and a similar function could be compiled and installed on a Digital Signal Processing chip to perform peak power reduction in a real system.

A function could be developed which analyzes the data in the frequency domain, and adds energy in certain FFT bins which fall outside the band of interest in such a way as to reduce the peak power of the composite signal after it has been reconverted to time domain. The function would operate to produce the Base Band OBPPR signal by generating energy at the intermodulation frequencies of the communication signal, with the appropriate phase to reduce the peak to average power ratio of the composite signal. Furthermore, the RF OBPPR signal could be generated by generating energy at the odd harmonics of the communication signal with the appropriate phase as to further reduce the peak to average power ratio of the composite signal.

In cases where adaptive digital predistortion is used, the clipped signal which exits the last PPR Stage at 28, is fed to a block which performs the Adaptive Digital Predistortion Functionality 27. This block takes the signal at 28 at its input, and compares the signal which is being supplied by the Input from the DPD Observation Receiver at 29. The algorithm will try to adjust the amount of predistortion to apply to the out-going signal so that the input signal at 28 and the observation signal at 29 are identical. Many various implementations of power amplifier linearization algorithms have been implemented and proposed, and this functionality is included in the block diagram for completeness. The presence of the OBPPR signal may have an impact on the ADPD algorithms since it increases the bandwidth of the input signal at 28. Given that most of the energy is still within the original carrier or carriers, and the power spectral density of the OBPPR signal is considerably lower, combined with the fact that we have considerably lower peaks, the pre-distortion algorithm should continue to operate in a satisfactory way despite the increased bandwidth of the signal. It is certain that the linearizer algorithm could be made to work well by increasing the sample rate and bandwidth of the linearizer algorithm, transmit chain and observation receivers to accommodate some increase in bandwidth. Furthermore, a linearizer which incorporates memory correction capability as is typically used to linearize Doherty amplifiers should be able to effectively linearize a power amplifier which incorporates RF-OBPPR in the transmit chain, even if the observation receiver is not able to receive the portions of the OBPPR signal which are at the odd harmonics of the RF carrier. Most lower power Base Stations or customer premise equipment and user terminals do not use power amplifier linearization so Block 27 would typically only be present in mid to high power transmitters. Once the predistortion has been applied to the signal (for systems where it is present), the signal is sent to Digital IQ signal to DAC 30. For systems using an IF DAC or Digital RF, the signal is sent to Digital Up converter and Modulator 31. From here the signal can be sent to “Digital IF or RF to an IF or RF DAC 32”, where it is supplied to the DAC.

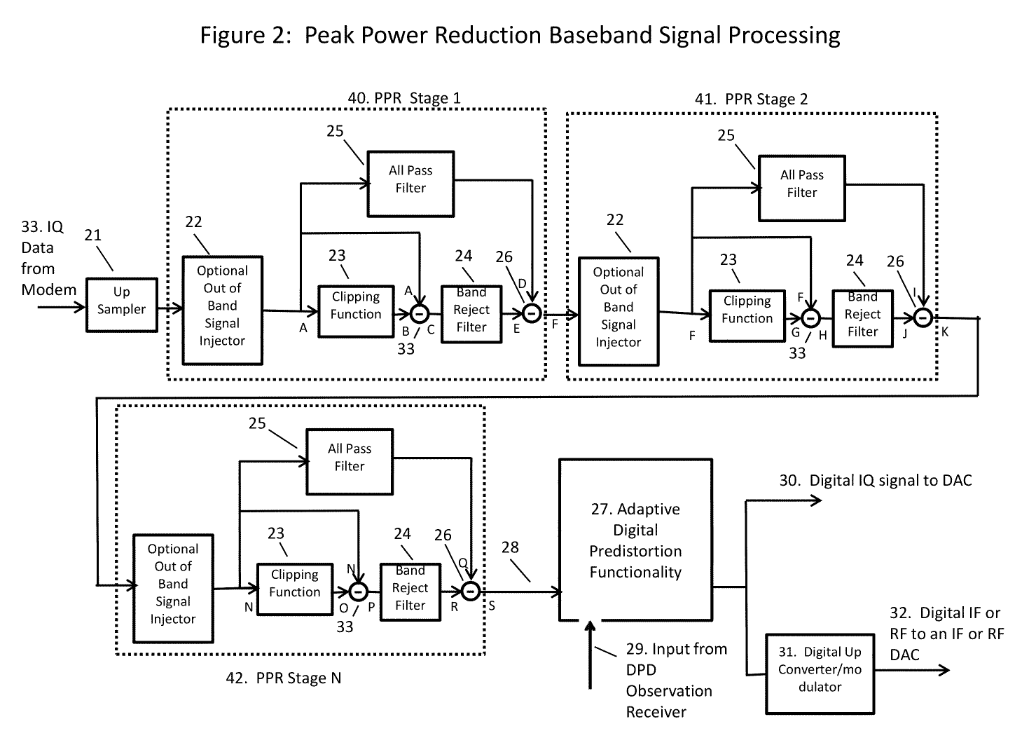

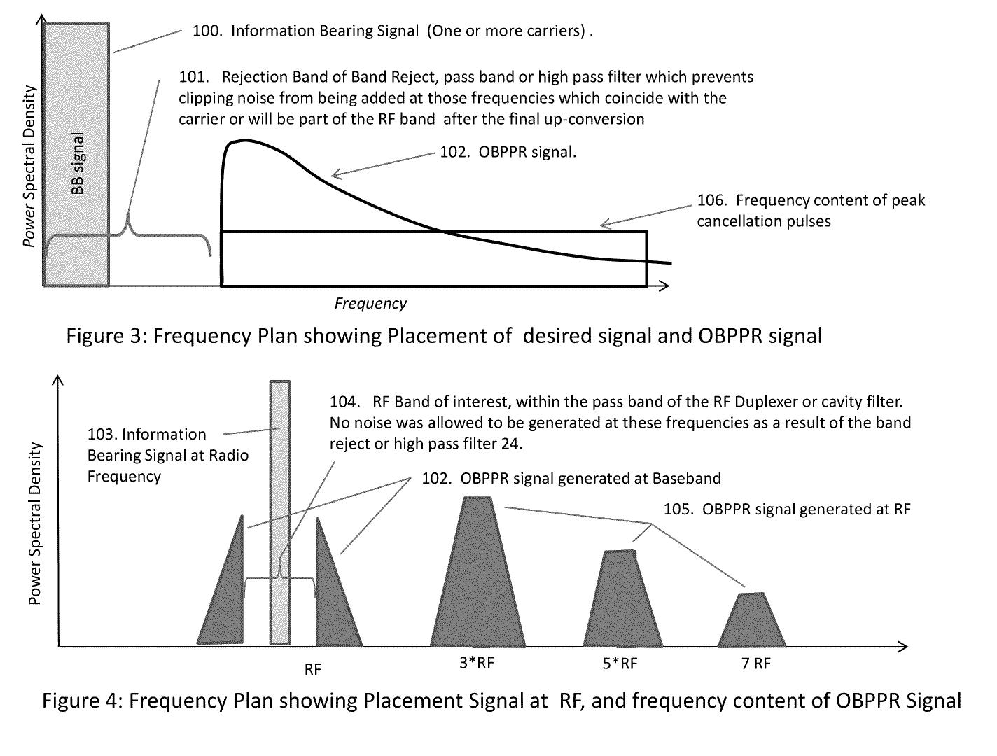

The signal processing aspects of the present invention can be further understood by examining FIGS. 3 and 4. The original signal at the output of the modem (IQ Data from modem 33), will have energy centered about the Baseband Frequency 100. At this point the OBPPR signal has not been generated and the energy of the signal is concentrated at Baseband. Given the desire to have the OBPPR signal some distance from the carrier, we identify the peaks and inject an out of band peak cancellation pulse using element 22 of FIG. 2. The peak cancellation pulse is designed to occupy frequencies which fall outside of the band of interest as shown by 106 and is added with the proper phase and at the appropriate time to reduce the peaks. As mentioned previously, the incorporation of the peak cancellation pulse is optional. The information bearing signal and the peak cancellation pulse go through the clipping or compressing function 23 together, which causes inter-modulation products to be generated over a wider bandwidth than if the baseband carrier 100 had been processed alone. After the signal passes through Clipping Function 23, significant amounts of out of channel energy are generated and the signal is filtered using a filter 24 with a rejection band depicted by 101. The filter rejects any portions of the distortion or clipping energy which fall around the information bearing signal as well as what will eventually coincide with the pass band of the TX filter 10. The bandwidth of the rejection band 101 (filter 24) should coincide with the pass band of the RF TX filter 10 to ensure that clipping energy is not permitted to propagate to the antenna. Once energy has been removed from the vicinity of the information bearing signal by the band reject filter 24, the remaining signal is the OBPPR signal. The OBPPR signal is then combined with the original signal which is free of EVM or distortion, to create a composite signal which has lower peaks. The clipping and filtering process can be repeated multiple times to increase the effectiveness of the OBPPR signal and achieve correspondingly lower Peak Powers. Finally, in the transceiver, the composite signal is eventually up-converted to RF by Up Converter 4. The up conversion process translates the frequency of the baseband carrier and the OBPPR signal to the desired RF frequency. The information bearing signal 103 is translated to the RF band in which the radio is meant to operate. The OBPPR signal 102 which was generated at baseband in this implementation is translated to a frequency above and below the operating band of the radio. Optionally, an OBPPR signal can be generated at RF, which will have the frequency content shown by 105. If the DSP electronics are fast enough, the RF OBPPR signal can be generated in the digital domain, or alternatively, an RFIC or MMIC based module can be build which performed the function. Once amplified by the Power Amplifier 5, the OBPPR signal is filtered by the RF TX Filter 10 since they do not fall within the RF TX Filter 10 pass band 104 and we are left with the up converted Information bearing signal 103. This allows the Power Amplifier to benefit from a signal with much lower peaks, while having a system which transmits a signal which meets regulatory requirements.

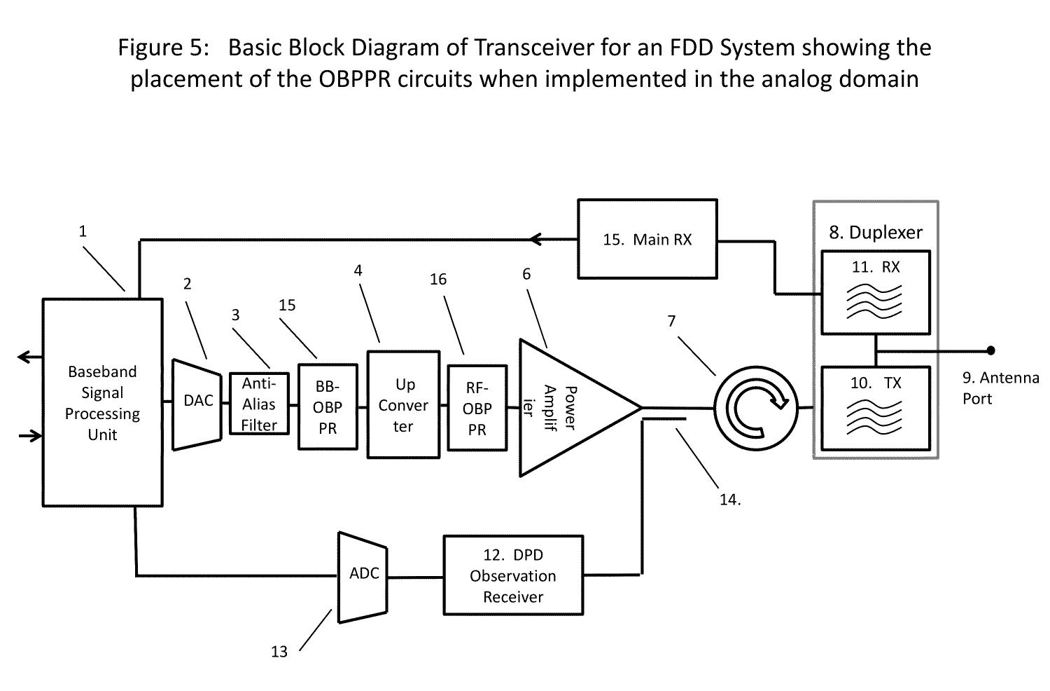

FIG. 5 shows a block diagram of an FDD transceiver where the Out of Band Peak Power Reduction circuitry is implemented in the analog domain as opposed to the digital domain. The diagram is very similar to FIG. 1 with the exception of the Baseband OBPPR circuit 15, and the RF OBPPR circuit 16. The baseband OBPPR circuitry is located after the anti-alias filter 3, and generates the baseband-obppr signal and adds it to the communication signal with the appropriate phase to reduce the peak power of the composite signal. The RF-OBPPR circuitry further reduces the peak power of the waveform by generating the RF-OBPPR waveform and adding it to the signal at an RF frequency. The baseband OBPPR waveform is comprised of intermodulation products of the communication signal whereas the RF OBPPR signal is comprised of the odd harmonics of the communication signal. It is possible to generate both the baseband OBPPR signal and RF OBPPR signal at an RF frequency with a single circuit but this is more complex to implement.

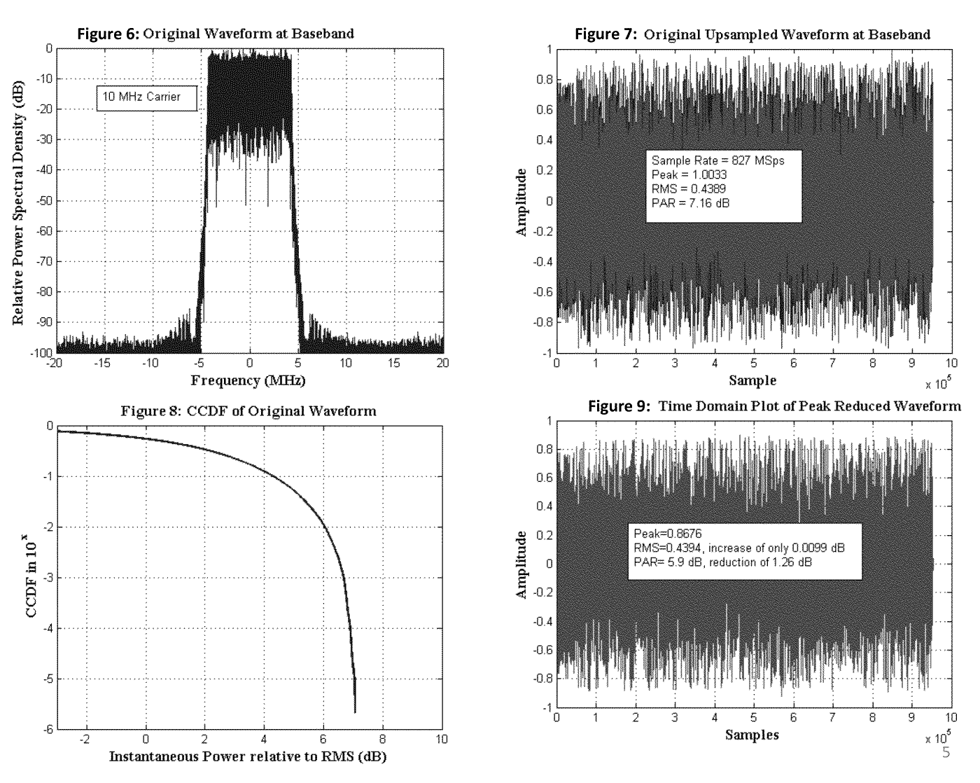

Let us now turn our attention to some simulation results which highlight the performance of this new method of performing peak power reduction. FIG. 7 shows a time domain response of a sample WiMax waveform at baseband. The waveform is a 10 MHz carrier which has been upsampled to 827 MSps. The Peak to Average Ratio of the signal is 7.16 dB, with a Peak Value=1.0033 and an RMS value=0.4389. The same data in the frequency domain can be seen in FIG. 6. The carrier is centered about DC and has a bandwidth of 10 MHz. FIG. 8 shows the CCDF of the Original waveform. It is important to note that this waveform has already undergone Peak Power Reduction using conventional methods of clipping and tone reservation, with an allowable EVM degradation to −32 dBc. Given the constraints the systems designer had, they were only capable of reducing the PAPR to 7.16 dB while maintaining an EVM of −32 dBc. Any incremental peak power reduction we are able to achieve will be above and beyond what was accomplished using current state of the art methods and we will do so without introducing any meaningful amounts of EVM or capacity degradation.

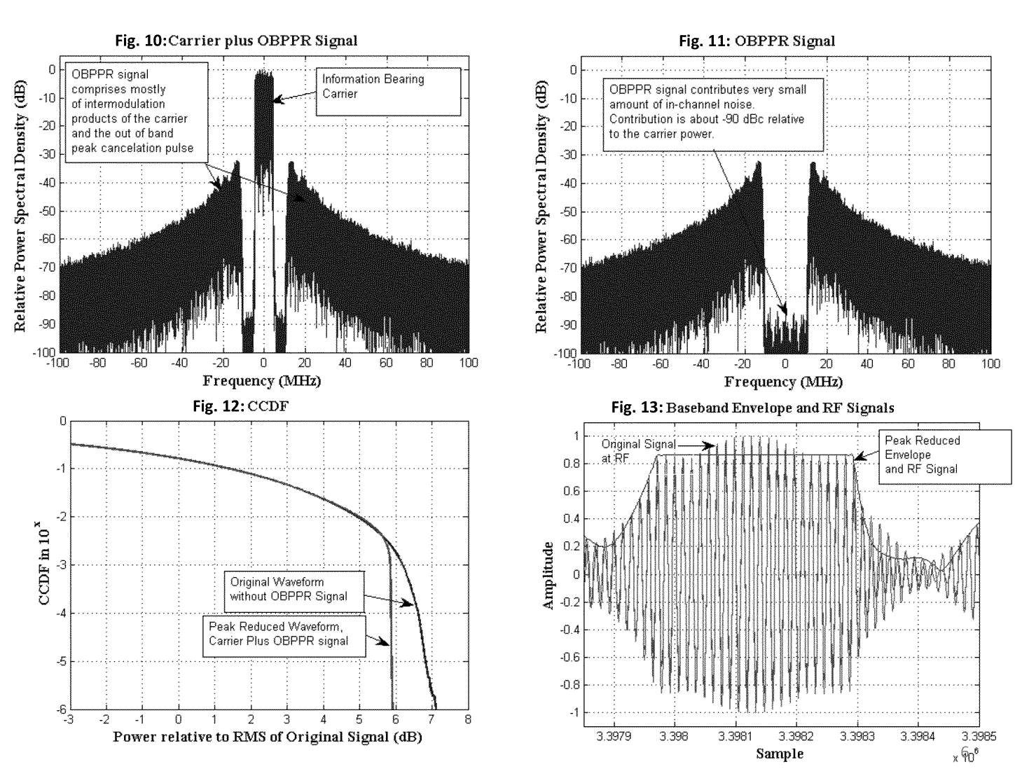

Next, let us look at the waveforms after it has been processed by the new peak power reduction system. FIG. 9 shows a time domain plot of the peak reduced waveform. The maximum excursion is now 0.8676 compared to 1.0033 for the original data. This represents a peak power reduction of 1.2 dB, which is very significant given that the original waveform had already undergone peak power reduction. The RMS power increased only very slightly, to 0.4394 from 0.4389, which is an increase of 0.0099 dB. FIG. 10 shows a frequency domain plot of the baseband carrier with the added OBPPR signal. The carrier has the highest power spectral density and is centered at DC. The OBPPR signal has the highest power spectral density immediately adjacent to the carrier and occupies frequencies from +/−12 MHz to either side of the carrier and has a reasonable power spectral density all the way out to +/−60 MHz. Given that the protected band is 20 Mhz wide, the implementation shown here as way of example could be used in a system where the TX Filter 10 has a passband of 20 MHz or less. FIG. 11 shows the OBPPR signal stand alone in frequency domain. This is the out of band signal which has been added to the original carrier to effect a reduction in peak power. The in-channel energy is quite low at minus 85 dBc relative to the power spectral density of the carrier. What this means, is that the contribution to EVM of the OBPPR signal is essentially −85 dB, which is very negligible, even for the highest modulation orders which are currently used. The contribution to EVM could be allowed to increase by designing a band reject filter with less rejection. For comparison, the basic transceiver, if well designed, has an EVM contribution of about −40 dBc, which is many orders of magnitude greater than the contribution of the OBPPR signal shown here. Conventional Peak Power Reduction Algorithms which place clipping energy in-band can have an EVM contribution as high as −20 dBc, or essentially will seek to use as much of the EVM budget as is considered acceptable by the system designers to achieve a reduction in peak to average power ratio. FIG. 12 shows the CCDF plots of the original and the peak reduced waveforms. The curves track very well at lower powers. At a Peak to Average Power Ratio of 5.7 dB, which has a cumulative complementary probability of less than 0.5%, the waveform which is peak reduced using the OBPPR signal falls below the original waveform and reaches a maximum PAPR of only 5.9 dB while the original waveform has a maximum PAPR of 7.16 dB. This is a very significant achievement given that the original waveform has already been peak reduced using two state of the art algorithms. This also implies that this new method of implementing peak power reduction by injecting energy out of band, is additive with conventional methods which place energy within the carrier itself such as clipping and filtering the carrier, or tone reservation.

A zoomed in plot showing the time domain response of the Original and the Peak Reduced waveform are shown in FIG. 13. Both waveforms have been up-converted to the Radio Frequency using an IQ modulator. The original waveform extends over a greater amplitude range than the waveform which has been peak reduced using an OBPPR signal. Furthermore, careful examination shows that the envelop of the peak reduced waveform has been flattened, with lower peaks but higher corners, as a result of the OBPPR signal. Sharp corners are possible with the increased bandwidth of the OBPPR signal. The original waveform can be recovered by filtering off the OBPPR signal using a passband filter as shown in FIG. 14. By doing so, the restored waveform is almost identical to the original waveform. For the sake of this simulation we chose an RF=487 MHz. Higher RF frequencies can be used in practise, but for the sake of this simulation we preferred to limit the size of the arrays, and therefore chose this RF frequency. By filtering the peak reduced waveform at RF, with the passband filter shown in FIG. 14, the OBPPR signals are attenuated by more than 50 dB, and the original waveform is recovered. If we subtract the recovered waveform from the original waveform, we find that the error is typically less than 0.001, which is an error of about −60 dBc. The error is not in-channel, but rather a result of the finite rejection (approx 60 dB) of the pass band filter. The inchannel EVM is governed by the rejection of the band reject of high pass filter used to filter the OBPPR signal, which in this case is approximately −85 dBc.

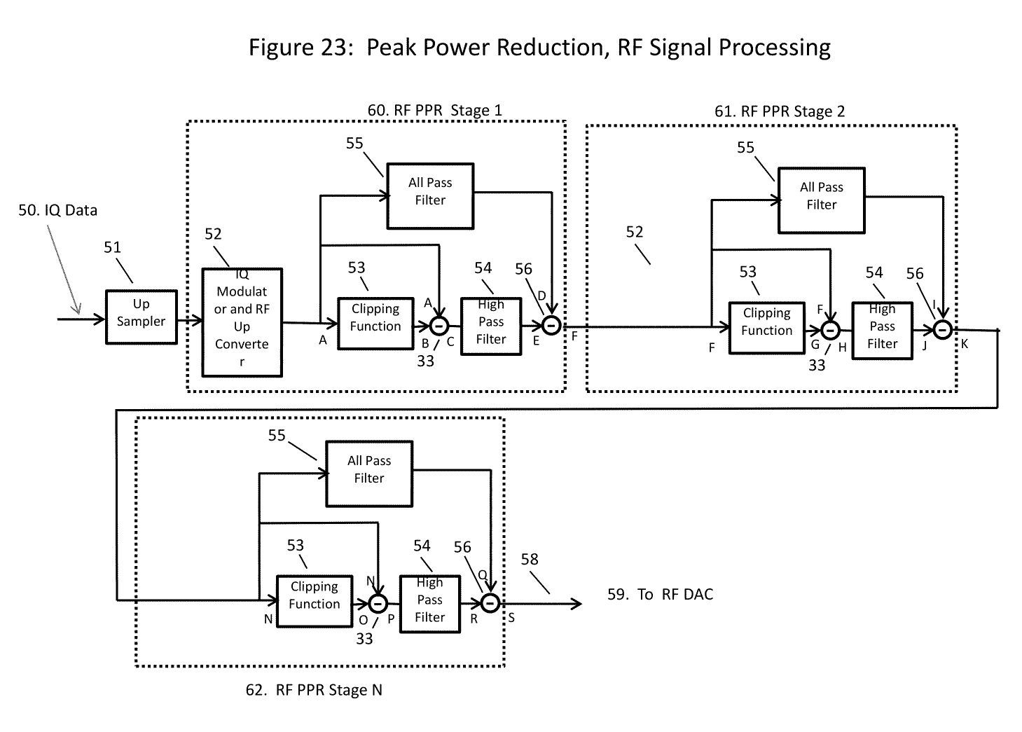

If the speed of the available DACs and digital signal processing devices is fast enough, the procedure described above can be repeated in the Digital Domain once the signal has been up converted to RF to obtain further peak power reduction. A block diagram which can perform peak power reduction by generating an OBPPR signal at RF frequencies is shown in FIG. 23. The IQ Data from the original waveform, or a waveform which has already been peak power reduced at baseband enters the block diagram at 50. The IQ data is up-sampled to a sufficiently high sample rate to allow processing at the RF frequency by Up Sampler 51. To be able to achieve reasonable amounts of peak power reduction, the sample rate should be high enough to generate the 3^{rd} harmonic of the RF carrier, preferably the 5^{th} or even 7^{th}. Next, the waveform is up converted to RF by IQ Modulator and RF Up Converter 52. The remaining blocks are identical to the baseband processing. The waveform is clipped or compressed by Clipping Function 53. The difference of the original waveform (A) and the clipped waveform (B) is calculated, C=A−B. The value C is the distortion which was introduced by the clipping function 53. The waveform C is then filtered using High pass filter 54 to remove any distortion around the RF carrier of interest to yield signal E. E is the distortion which did not fall near the RF carrier, and which can be subtracted from the signal to effect some peak power reduction. Next, the filtered OBPPR signal is subtracted from the delay and phase adjusted input signal D, F=D−E. The signal F is the peak reduced waveform which includes the original input signal at A plus the RF OBPPR signal. This process can be repeated numerous times with different clipping functions to achieve a desired peak power reduction. Once the signal exits the last peak power reduction stage, it is sent to RF DAC 59 such that it can be converted to an RF analog waveform.

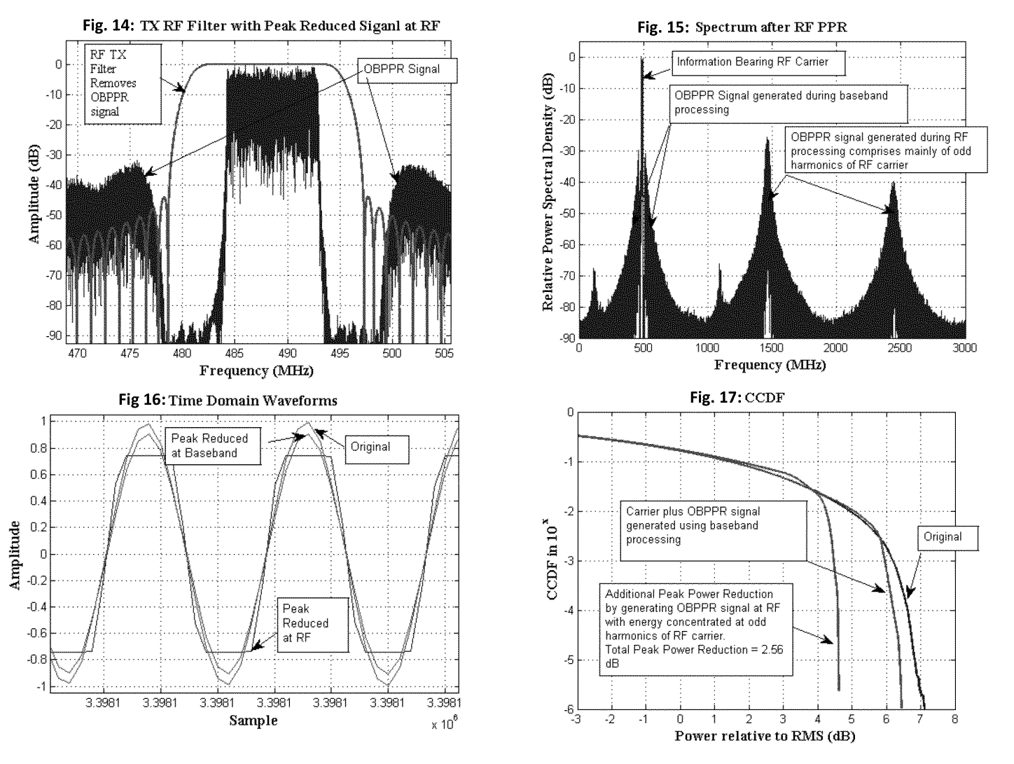

High Pass Filter 54 should be designed to reject any distortion energy around the carrier. The cut off for the filter would typically be somewhere between the fundamental and 3^{rd} harmonic of the RF carrier. When peak power reduction is performed at RF frequencies, the OBPPR signal has large amounts of energy at the odd harmonics of the RF carrier as shown in FIG. 15. Hence, designing the High Pass filter 54 to provide good rejection at frequencies slightly above the RF carrier, preferably out to the upper edge of the band of interest, and to provide a passband starting somewhat before the 3^{rd} harmonic is a reasonable choice. The information bearing signal can be seen at 488 MHz, with the OBPPR signal which was generated at baseband on either side of the carrier. The OBPPR signal which was generated at RF is concentrated at the odd harmonics of the RF carrier, in this case at 1464 MHz (3^{rd} harmonic) and 2440 MHz (5^{th} harmonic). Greater peak power reduction can be achieved by using faster sample rates, which allow higher order harmonics to be generated. At RF, there is little benefit to injecting an out of band Signals using block 22 since most of the peak power reduction is accomplished by clipping the RF carrier as shown in FIG. 16. FIG. 16 shows the Original un-processed waveform after it has been up converted to RF, as well as the waveform which has been peak power reduced at baseband and the final waveform which has been peak power reduced at both baseband and RF. For the Baseband peak power reduction, only the modulation envelop has been affected but the RF carrier remains pure. For the waveform which was processed at RF, the actual RF carrier is clipped, having flat tops, hence the strong content of the odd harmonics in the RF OBPPR signal. It is important to note that although we have clipped the RF carrier and created large amounts of distortion at the odd harmonics, there is no distortion in band to the carrier and hence the un-distorted information bearing carrier can be recovered by filtering the OBPPR signal. This is a key difference compared to systems which generate non-linearities where distortion energy is present at the harmonics of the information bearing signal as well as within the channel itself and as a result the signal quality is compromised. For OBPPR we generate energy at the odd harmonics as well as the odd order intermodulation products, but not in channel. As such we are able to achieve a very significant level of peak power reduction with no degradation in the quality of the communication signal. Furthermore, the process is fully reversible by using a filter to selectively allow the communication signal to pass while filtering off the OBPPR signal.

FIG. 17 shows the relative benefit of performing peak power reduction at baseband and RF. The original waveform which had previously been peak reduced using previous state of the art methods has a PAPR of 7.16 dB. For the carrier which has been peak reduced at baseband by generating an OBPPR signal, an additional 0.8 dB of peak power reduction has been achieved for a total PAPR=6.4 dB. Finally, if we combine baseband and RF peak power reduction, an additional peak power reduction of 1.8 dB was achieved to arrive at a final PAPR=4.5 dB. Taking a Wimax signal, and reducing its PAPR to 4.5 dB, without introducing any EVM, is a very significant accomplishment.

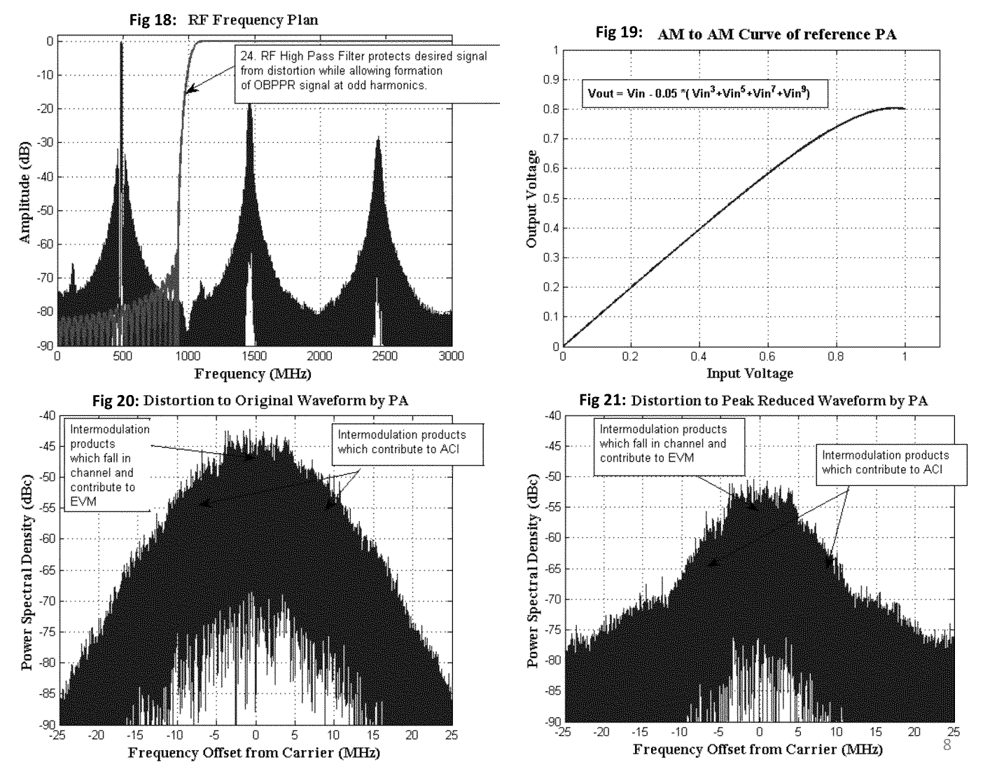

FIG. 18 shows the spectrum of the signal which was peak reduced at RF, along with the High Pass Filter which coincides with element 54 in FIG. 23. The High pass filter is designed to allow the energy at the odd harmonics of the fundamental, but to reject distortion energy around the carrier. In this case the rejection band is from DC to 2*RF frequency.

Let's now examine the impact that a wideband signal would have on distortion created in the Power Amplifier. We have achieved very significant amounts of peak power reduction by creating an OBPPR signal at baseband and then RF. The signal peaks are significantly reduced, but the spectral content of the signal has increased significantly. FIG. 19 shows a simple polynomial which we will use to approximate the AM to AM distortion introduced by a Power Amplifier. FIG. 20 shows the spectral content of the Distortion Signal when the original signal is passed through the PA. FIG. 21 shows the spectral content of the Distortion Signal when the Peak Reduced Signal is passed through the PA. As we can see, despite the large spectral content, the peak reduced waveform has considerably less in-channel and adjacent channel distortion than the un-peak reduced waveform. The original waveform has in-channel distortion energy at about −45 dBc while the peak reduced waveform has only −53 dBc of in-channel distortion. In the first adjacent channel, the original waveform has an ACI of about −50 dBc while the peak reduced waveform achieves −58 dBc. As such, for a system which does not linearize the power amplifier, the advantages of this new method of implementing peak power reduction are clear. For systems which used Adaptive Digital Predistortion, it should be possible to achieve good levels of correction by only observing around the carrier +/− a few carrier bandwidths as is currently done.

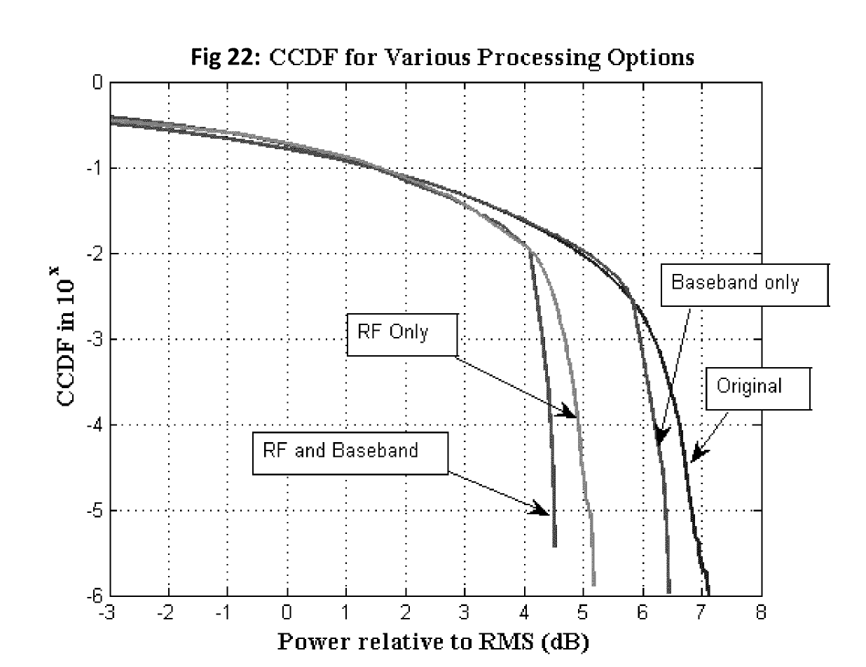

Finally, it should be mentioned that it is possible to do RF peak power reduction without first performing baseband peak power reduction. FIG. 22 shows 4 curves. The original curve depicts the CCDF of the original signal which has not been processed, and has a PAPR=7.16 dB. The “Baseband only” curve was peak reduced by generating an OBPPR signal at baseband. Approximately 0.8 dB of peak power reduction was achieved. The “RF only curve” shows the CCDF for a signal which has only under gone RF peak power reduction. No OBPPR signal was generated at baseband. In this case, the original waveform with a PAPR=7.16 dB was up-converted to RF, and the RF OBPPR signal was generated and added to the waveform, which yielded 1.61 dB of peak power reduction for a total PAPR=5.55 dB. Finally, the “RF and Baseband” curve shows what is possible if the signal is first peak reduced at baseband, and then up-converted to RF and peak reduced again. The total Peak Power Reduction in this case was 2.6 dB, for a total PAPR=4.51 dB. It is of interest to note that the amounts of PAPR achieved at baseband and RF are approximately additive.

It would be possible to generate the full amount of peak power reduction at RF, by using a very resource expensive band reject filter as opposed to High Pass Filter 54. In this example, to achieve the same level of performance, the band reject filter would need to be about 20 MHz wide to protect the RF band from distortion, and role off quickly enough to allow the OBPPR signal to form immediately adjacent to the RF band, in addition to the odd harmonics of the carrier. Implementing such a filter at sample rates sufficiently high to support the 3^{rd} and potentially 5^{th} harmonics of the RF carrier, would require many taps and be very resource expensive. It is more cost effective to first generate the OBPPR signal at baseband and then repeat the same procedure at RF using a much wider, less expensive, high pass filter 54 with fewer taps.

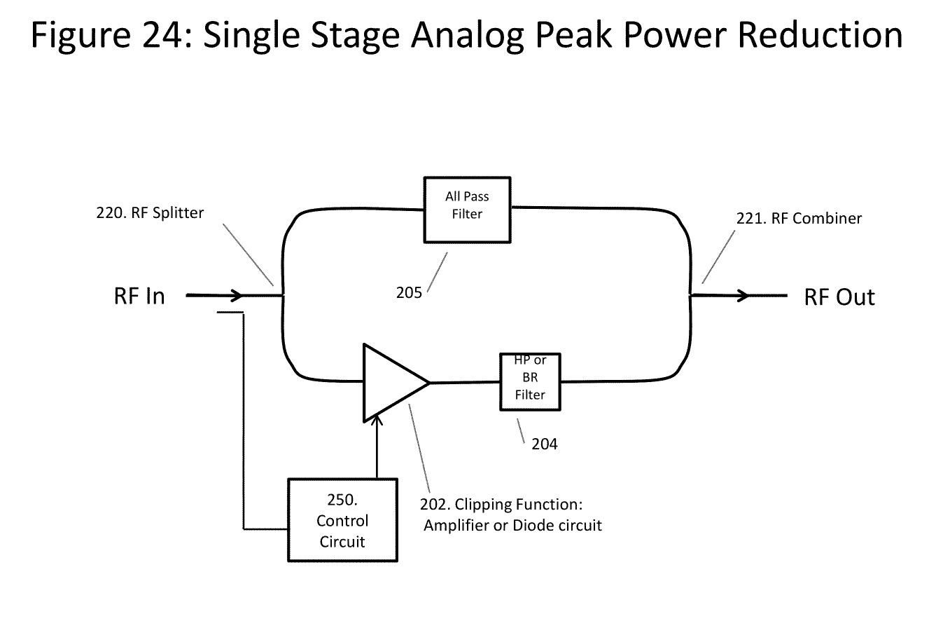

In closing, it is interesting to point out that for the first PPR Stage 60 at RF, or 40 at Baseband, the circuit could be simplified slightly. For the first stage, subtraction block 33 of FIG. 2, and subtraction block 33 of FIG. 23 are not necessary. The clipped function B can be filtered directly and then re-incorporated to the original waveform D by changing element 56 and 26 to a summation block as opposed to a subtraction. This however can only be performed for the first PPR stage. After the first stage, if we omit the subtraction blocks 33, the OBPPR signal which had be generated in previous stages passes through the filter 54 and 24 unimpeded and gets re-incorporated into the OBPPR signal once again, causing the OBPPR signal to grow beyond the optimal value, and the composite signal's peak and RMS power to increase substantially. For the first stage however, eliminating the first subtraction step, and changing the second to a summation, is equivalent to having the two subtraction elements, since the signal does not include an OBPPR component and hence it does not need to be subtracted prior to filtering. If we wanted to implement a single stage RF PPR circuit as an analog module which processes an RF signal, then a circuit similar to FIG. 24 could be used.

FIG. 24 depicts an analog implementation of our out of band peak power reduction system. This module would be implemented in the transmit chain, before the Power Amplifier, to limit any unnecessary insertion loss after the signal has been amplified to an elevated power and to allow the Power Amplifier to benefit from the reduced peak power. The RF signal enters the circuit on the right hand side and is divided into two paths by RF Splitter 220. The OBPPR signal is generated by first passing RF waveform through the Clipping Function 202. The clipping function could be an amplifier which is specifically designed to clip the peaks of the RF carrier and provide approximately unity gain. Furthermore, the Clipping Amplifier 202 could be controlled by some form of peak detector and logic circuit 250 which determines the optimal amount of clipping to perform on the waveform as the RF power goes up and down as a function of traffic changes or power control. The Clipping Function 202 could also be implemented using diodes, but this offers less flexibility than a clipping amplifier which is implemented in a RFIC. The High Pass Filter 204, needs to reject the waveform as well as any distortion which has been generated around the RF carrier of interest, but allow the OBPPR signal which is concentrated at the odd harmonics of the RF carrier, to pass. The All Pass Filter 205 is designed to provide the same amplitude, phase and delay as the lower branch, to allow the OBPPR signal to add with the appropriate phase, with the un-distorted carrier which is propagating throught the upper branch. At combiner 221, the OBPPR signal with energy concentrated at the odd harmonics of the RF carrier, as well as the un-distorted RF carrier, are combined to obtain a peak reduced signal with very negligible amounts of EVM or distortion introduced in-band.

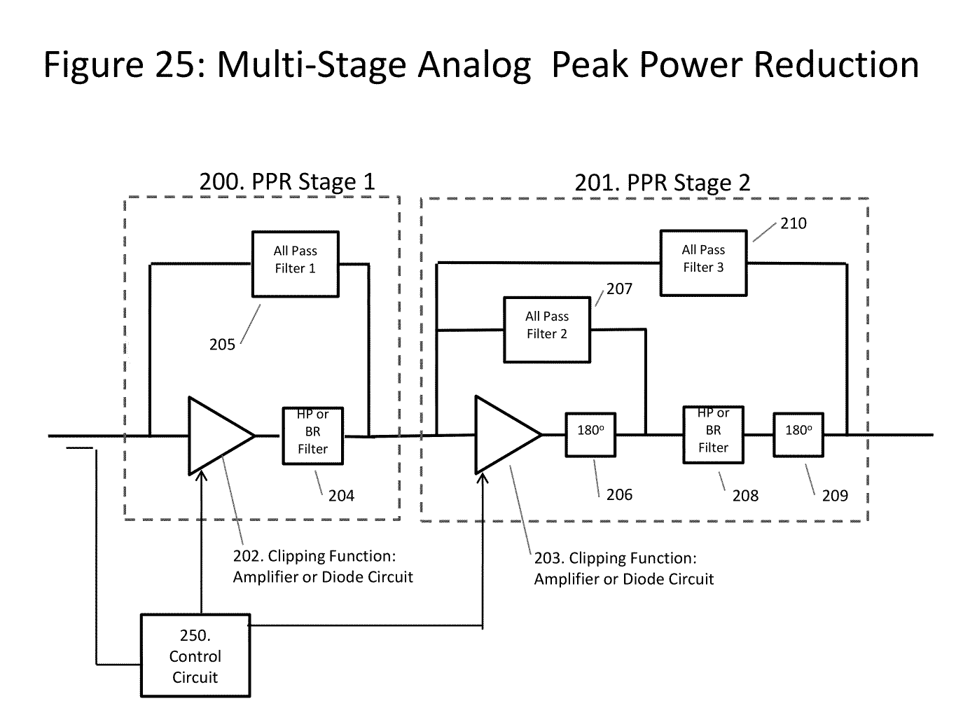

FIG. 25 depicts a Multi-Stage Analog Peak Power Reduction Circuit, which could be implemented on an RFIC or MMIC. The PPR Stage 1, 200, is functionally identical to the circuit described in FIG. 24. PPR Stage 2, 201, is functionally equivalent to element 61, RF PPR Stage 2 in FIG. 23. As discussed earlier, for the PPR Stage 1, 200, we do not need to subtract the clipped signal from the incoming signal, since the incoming signal does not contain an OBPPR component. Hence filtering the clipped waveform to remove the in-band component, and then re-adding it to the un-distorted carrier will yield substantial peak power reduction. For subsequent stages, such as PPR Stage 2, element 201, the incoming signal already contains an OBPPR component. Hence the clipped waveform coming out of Clipping Amplifier 203, would include a portion of the previous OBPPR signal which would fall in the pass band of High Pass filter 208. By subtracting the incoming signal from the clipped waveform, we essentially prevent the previously generated OBPPR signal from being re-incorporated into the OBPPR component which is being generated in this processing stage. By performing this subtraction step, we can essentially stagger as many PPR stages as we need to achieve a desired level of peak power reduction. In an RF IC, the subtraction of two signals can be accomplished by introducing a wideband phase inverter 206 and 209 to one of the waveforms, and then combining the two waveforms. The wideband phase inverter can be implemented in many ways which are known in the art. On an RFIC one of the most economical methods of implementing a broad band phase inverter is to use a gain block with a 180 degree phase shift such as a common emitter amplifier. Another method when the RFIC is implemented using a Differential Type circuit, is to invert the differential tracks so that the positive signal is now the negative signal and the negative signal becomes the positive signal, to effectively create a wide band 180 degree shift.

The circuit shown in FIGS. 24 and 25 could also be implemented at baseband as well as at IF or RF frequency. Implementing the circuit at baseband would allow the baseband peak power reduction to be performed in an RFIC, after the DAC has converted the digital waveform to an analog waveform. If the processing is performed at an IF, as opposed to Baseband or RF, then the Filters 204 and 209 would need to be a combination of a Band Reject Filters and High Pass Filter as opposed to High Pass filters. For an IF implementation, the OBPPR signal should preferably not include harmonics of the IF. Harmonics of the IF will reduce the Peak Power of the composite signal at IF, but after the up-convertion to RF these frequency components will nolonger combine with the appropriate phase to effect peak power reduction, but rather can cause an increase in peak power. As such, to ensure harmonics of the IF are not incorporated into the OBPPR signal, the Filters 204 and 209 should provide a rejection band around the Information Bearing Signal, then a pass band or high pass filter over the information bearing signal to allow portions of the OBPPR signal to form, and then start rolling off to provide significant rejection at the 3^{rd} harmonic of the IF and beyond in order to reject harmonic contents of the IF within the OBPPR signal.

It should be mentioned that it is possible to alter the logical operators in FIGS. 2, 23 and 25 without changing the function. For example currently C=A−B (Distortion=Incoming-Clipped waveforms) and F=D−E=E-Filtered(C). If we changed the logic so that C=B−A (Distortion=Clipped-Incoming waveforms) then the final logical operation would change from a subtraction to a plus such that F=E−D. Other games could be played by introducing inverters and other operations to change the block diagram or algorithm but effectively perform the same task, and they do not depart from the spirit of the invention being disclosed here.

Although we have focused and shown the potential of implementing peak power reduction by injecting an out of band signal, the OBPPR signal, we have also shown that this new method can be used additively in combination with other methods currently known in the art which perform peak power reduction by adding energy within the carrier itself such as tone reservation, constellation mapping or clipping and filtering the carrier. Conventional Peak Power Reduction Methods could be applied first, at lower sample rates, and then the OBPPR signal could be generated and added to the waveform subsequently to effect additional peak power reduction. Conversely, for some systems it may be beneficial to perform peak power reduction by first using the out of band method described here, and then use traditional in-band methods to complete the desired level of peak power reduction. The disadvantage of this sequence is that the traditional methods which could have been performed at lower sample rates, will now need to be performed at higher sample rates given that the OBPPR signal has increased the bandwidth of the waveform. Yet another approach would be to perform peak power reduction by generating an OBPPR signal, and performing in-band peak power reduction concurrently. This might allow a desired level of peak power to be achieved while limiting the amount of EVM introduced in-band by allowing as much of the peak power reduction to be performed by the OBPPR signal as possible. This method could be combined with conventional methods to produce a unified approach to implementing peak power reduction.

The author performed a simulation to compare both methods and obtained very nearly identical results. In the first simulation, in-band and out of band peak power reduction were performed sequentially. First, in-band peak power reduction was performed until a desired maximum EVM was obtained. Then, Out of Band Peak Power Reduction was performed to bring the PAPR down as far as possible. In the second simulation, a loop was designed where Out of Band Peak Power Reduction is performed first, and In-Band Peak Power Reduction is only performed when little to no incremental Peak Power Reduction is being achieved by the OBPPR algorithm. Once the In-Band Peak Power Reduction has been performed, the OBPPR is repeated. The two simulations gave very similar result in terms of the Peak to Average Power Ratio which could be obtained for a given EVM.

For systems which have an elevated RF frequency, or for systems where high speed digital signal processing is too expensive, the functionality could be implemented in the analog domain as opposed to the digital domain. The circuits shown in FIG. 24 and FIG. 25 could be implemented at Baseband, IF or RF. For some systems, it may be cost optimal to first perform traditional peak power reduction in the digital domain at moderate sample rates. After the DAC, additional out of band peak power reduction could be performed using a circuit as shown in FIG. 25 to create the baseband OBPPR signal. Finally, after the modulator/up converter, the second RFIC could be used to generate the RF OBPPR signal to generate greater peak power reduction.

Furthermore, in the example provided we have focused on a single 10 MHz carrier. It should be clearly understood that this method could be used on a multi-carrier system and even a multi-carrier GSM system where the individual carriers are frequency hopping, or a multi-band system where two carriers are being excited in different bands and being sent to the same PA. The circuits and algorithms described herein can work on any carrier configuration.

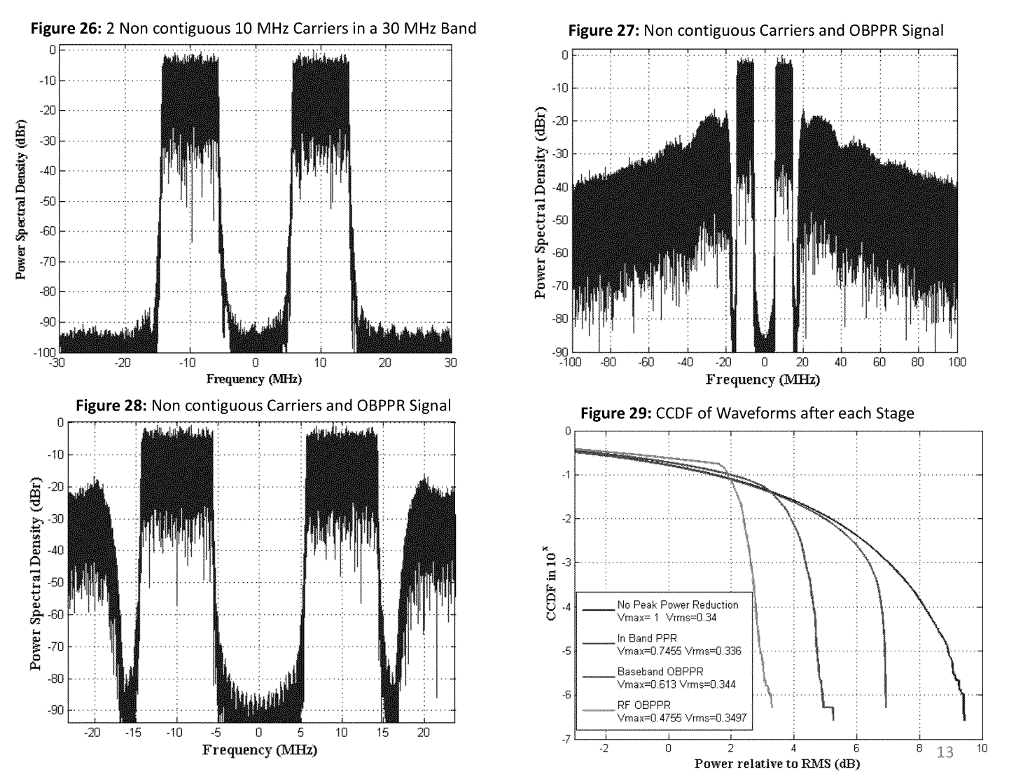

As way of example, FIGS. 26 to 29 highlight how the system could be used for 2 non contiguous carriers. Two 10 MHz, OFDM carriers are positioned with a 10 MHz gap between them as can be seen in FIG. 26. This type of non-contiguous deployment is occasionally used by operators when they own two pieces of spectrum which are not side by side and the actual spacing between the carriers can vary depending on the situation. In this case, we assume a 10 MHz gap by way of example, but have also performed the simulation with a 50 Mhz gap and obtained similar results. FIGS. 27 and 28 show the two carriers and the close in OBPPR signal after the baseband OBPPR signal has been generated. In this case, the bandwidth of the protected zone is 34 MHz. FIG. 29 shows the CCDF for the various signals. The unprocessed signal has a PAPR of 9.4 dB. Using in-band Peak Power Reduction we are able to reduce the PAPR down to 7 dB while having an EVM of about −25 dB. Next, the baseband OBPPR signal is generated and the PAPR of the composite waveform is reduced to 4.7 dB. Finally, after the RF OBPPR signal is generated, the composite waveform has a PAPR of 3.3 dB @ 10⁻⁶ probability, which is extremely low by current standards. In this example the OBPPR algorithms performs better, and achieve a greater level of peak power reduction that in the single carrier example provided earlier. Another simulation was performed where the same two carriers were separated by 50 MHz and very similar results were obtained except that the PAPR lower by a few 10 ths of a dB.

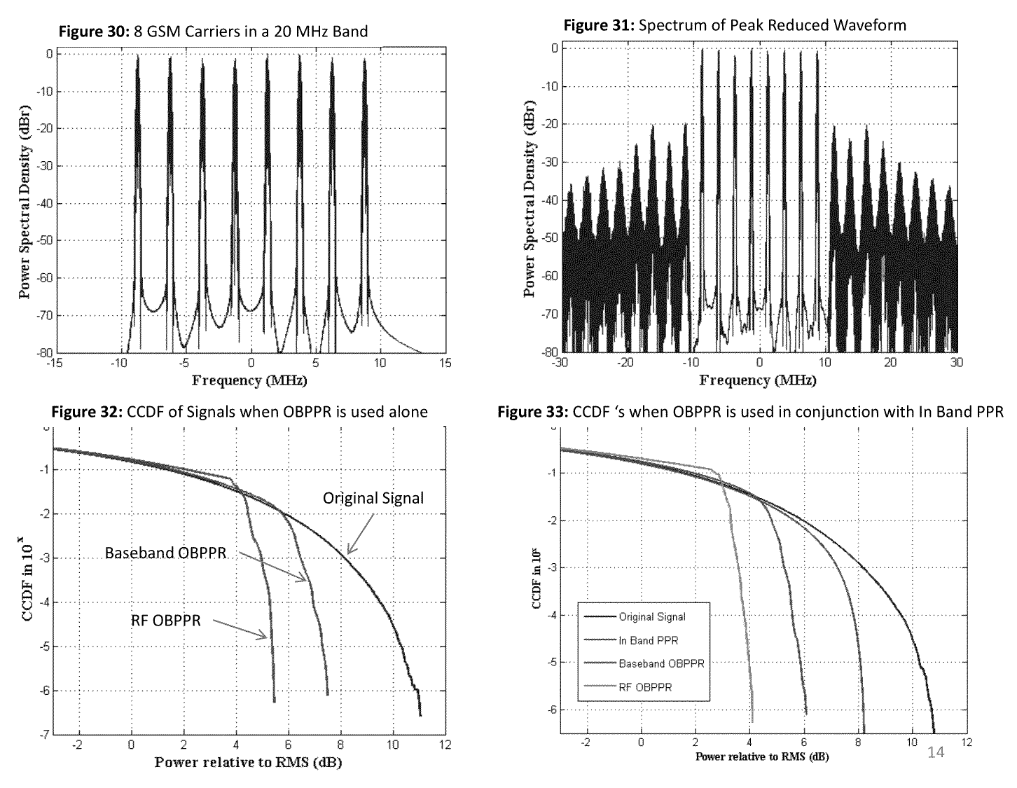

A third simulation was performed to evaluate the potential for this method when used in conjunction with Multi-Carrier GSM. FIG. 30 shows 8 GSM carriers, spaced by 2.5 MHz and occupying a 20 MHz band. The GMS spectral mask is very demanding and the signal has a noise floor of about −70 dBc between the carriers. Multi-carrier GSM is known to exhibit very high peak to average power ratios and the initial 8 carrier waveform has a PAPR of 11 dB as can be seen in FIG. 32. FIG. 31 shows the frequency domain spectrum of 8 GSM carriers with the baseband OBPPR signal. The energy of the OBPPR signal is concentrated in discrete bands in a similar manner to the Multi-Carrier GSM signal and is comprised of intermodulation products of the GSM carriers. The noise floor within the 20 MHz band remains at −70 dBc and was not affected by the generation of the OBPPR signal.

Traditional In-Band Peak Power Reduction techniques are not very effective with multi-carrier GSM due to the narrow bandwidth and frequency hopping nature of the carriers. FIG. 32 shows the performance of the OBPPR system when no in-band PPR was performed. The baseband OBPPR signal is able to reduce the PAPR from 11 dB down to 7.5 dB. Second, the RF OBPPR signal is able to reduce the PAPR down further to 5.4 dB.

A second simulation was performed for the Multi-Carrier GSM scenario when In-Band Peak Power Reduction is used in conjunction with OBPPR. In this scenario we initially performed in-band peak power reduction and reduced the PAPR from 11 dB down to 8.2 dB while allowing the EVM to degrade to −25 dBc, which is compatible with a 64 QAM modulation. Secondly, the baseband OBPPR signal was generated which reduced the PAPR down to 6 dB. Finally, the RF OBPPR signal was generated which reduced the PAPR to 4.1 dB.

Both of these simulations show the tremendous potential of the OBPPR approach for Multi-Carrier GSM. Using methods which are currently known in the art, Multi-Carrier GSM base stations currently have to contend with a PAPR of 8 dB if in-band PPR is used, or higher if it is not used.

The following examples have highlighted the advantages of Out of Band Peak Power Reduction, and the tremendous performance that can be achieved and we have described two forms of OBPPR signals which can be generated. The first OBPPR signal is at a frequency offset which is relatively close to the information bearing signal and comprises of Intermodulation Products of the information bearing signal. We have mentioned that this OBPPR signal can be generated at Baseband, at an IF or even at RF frequencies. However, given that the filter 24 and or 54 would need to provide a rejection band which essentially protects the Information Bearing signal from distortion, while providing a passband relatively close to the information bearing signal, the band reject filter 24 and or 54 would need to provide a sharp transition band at an RF frequency which is a difficult design. If the function is implemented in the Digital domain, the filter would need to have a large number of taps and be implemented at an elevated sample rate. If the function is implemented in the analog domain at RF, the filter would require components with a high quality factor, and could be fairly large and expensive. It is possible however to implemented RF band reject filters, which are both cost effective and small as has been described by Beaudin et al. in U.S. Pat. No. 7,777,597, U.S. Pat. No. 6,924,715 and U.S. Pat. No. 6,710,677. By combining an RFIC with SAW or FBAR Band Reject Filter, or another form of Band Reject Filter implemented in ceramic, waveguide, cavity filter or any other method known in the art of filter design, it would be possible to generate both the close in and RF OBPPR signals with a single circuit or module.

Furthermore, if we implemented a multi-band system, where the radio or terminal is designed to transmit 2 or more carriers such that the two carriers are spaced at a considerable frequency apart, such as two different RF bands, it would be possible to implemented an RF circuit, which is capable of generating both the close in OBPPR signal which comprises of intermodulation products of the information bearing carriers, as well as the RF OBPPR signal which comprises of the odd harmonics of the information bearing signals, in an RFIC with low cost filters. If the frequency separation between the two carriers is sufficiently large, the RF Filters 24 and or 54 could be implemented with low cost Inductors or Capacitors either on chip or on board which would make the generation of the OBPPR signal very low cost and suitable for cost sensitive applications such as wireless handsets, Micro, Pico or Femto Cells and WiFi equipment. Furthermore, even if SAW, FBAR or Ceramic filters need to be used, the components will be more easily designed, smaller and less expensive, if the required transition bands are wider.

As way of example, the PCS Bands consists of an Uplink band between 1850 MHz and 1920 MHz and a Downlink band between 1930 MHz and 2000 MHz. The AWS Band consists of an Uplink band between 1710 MHz and 1755 MHz and a Downlink band between 2110 MHz and 2155 MHz. It would be possible to design a Base Station which transmits a carrier in each of the Downlink Bands of the AWS and PCS band, or a terminal which transmits a carrier in each of the Uplink Bands of the AWS and PCS bands. In so doing, the transmitter of the base station or terminal, is transmitting two carriers which are somewhere between 95 and 225 MHz apart, which would allow a reasonable low cost RF circuit to produce both the close in OBPPR signal which comprises of the intermodulation products of the two carriers, as well as the RF OBPPR signals which comprises of the odd harmonics of the two carriers. In this type of a Dual Band implementation, rather than use a high pass filter 54, the filter would need to provide a rejection band and could be designed to provide a single rejection band which spans both uplink bands, in the case of a terminal, or both downlink bands in the case of a Base station. Alternatively, the filter 24 or 54 could be designed to have two rejection bands which coincide with each of the AWS or PCS bands. Using two rejection bands provides more flexibility, especially when the two RF bands are relatively far apart.

By way of example, for a Terminal which is designed to transmit a carrier in each of the Uplink Bands, the filter could have a first rejection band spanning from 1710 MHz to 1755 MHz and a second rejection band spanning from 1850 MHz to 1920 MHz. In this particular example, the RF TX filter 10 or duplexer 8 would also need to be designed to accommodate both bands. The transmit path of the handset duplexer would need to provide a pass band from 1710 to 1755 MHz and 1850 to 1920 Mhz. Any other set of bands could be used, so long as the Power Amplifier is designed to provide acceptable performance across a frequency which spans the two Frequency Bands in which the carriers are placed. The individual carriers can be generated by a common baseband modem and transceiver or could be generated by a separate baseband modem and transceiver. Different modems could be used in situations where each carrier is from a different standard, such as UMTS and LTE or CDMA and LTE, LTE and WiFi for example. Different transceivers could be used, in situations where the bandwidth of the transceiver is not large enough to generate both carriers simultaneously. When different transceivers are used, the carriers can be combined at RF, and then passed through a circuit which generates the OBPPR signal prior to the Power Ampifier. This scheme could also be done with more than 2 carriers. For example, a 3 carrier design could be developed where 3 carriers are transmitted concurrently, each in its own RF band. Alternatively, 2 carriers could be transmitted in one band and one carrier could be transmitted in another band. This could be extrapolated to 4, 5 or more carriers. Also, it is important to mention that the separate carriers do not need to have the same bandwidth. For example, some carriers could be 5 MHz Wide and other 10 MHz or 20 MHz wide, or any other bandwidth which is appropriate for a given technology or standard. Given the tremendous Peak Power Reduction that can be achieved with this newly proposed Out of Band Peak Power Reduction, it is conceivable that future wireless standards and spectrum planning could be developed to enable the transmission of two or more, non-contiguous carriers, or carriers in different RF bands or sub-bands, to facilite the generation of the OBPPR signal.

FIG. 36 shows a system designed to transmit multiple carriers at different frequencies where independent transmit chains are used to generate and up-convert each carrier to RF. Individual transmit chains 301, 302 and 303 are used to produce a carrier, or group of carriers at different frequencies. Potentially the carriers generated by each transmit chain could be in a different frequency band. Once at RF, an RF Combiner 305 is used to combine the different transmit signals onto a common path. The RF Combiner 305 could be a Wilkinson combiner which is commonly known in the art or any other type of RF combiner. The number of transmit chains could be 2, 3 or more. Once the multiple carriers have been combined, element 16 performs the Out of Band Peak Power Reduction at RF. If the frequency separation between the individual carriers is sufficiently large, the Band Reject filters 204, 208 and 54 (if implemented as a band reject filter as opposed to a high pass filter) could be designed to have seperate rejection bands which coincides with the transmit frequency or band of each of the individual carriers generated by transmit chains 301, 302 and 303. An example of such a band reject filter can be seen in FIG. 35. The filter has multiple pass bands 401, 403, 405 and 407 as well as multiple rejection bands 402, 404 and 406. The rejection bands would be designed to coincide with the frequency of the carrier or carriers which are being generated by transmit chains 301, 302 and 303. Using a filter with multiple rejection bands, and a pass band to either side of the multiple rejection bands, allows the most peak power reduction to be achieved since it allows OBPPR signal to be comprised of both the intermodulation components as well as the odd harmonics of the carriers generated by transmit chains 301, 302 and 303. The next element in the chain is Power Amplifier 6 which amplifies the composite waveform comprising of the multiple carriers generated by the individual transmit chains as well as the OBPPR signal which has been added to the communication signal to reduce the peak to average power ratio. The final element in the chain is the RF Filtering Block 306. For a multi-band system this filter could have multiple passbands to allow each of the information bearing carriers to pass while rejecting the OBPPR signal sufficiently to meet regulatory requirements and to prevent the out of band energy from interfering with other communication systems. It is also possible to have a filter with a single passband which spans the frequencies of all the communication carriers if the OBPPR signal was generated accordingly.

In this type of implementation, given that the final signal envelop is only available after the RF Combiner 305, it is not benefitial to perform Peak Power Reduction in the baseband processing unit 1 of each transmit chain. Peak Power Reduction can only be performed once the final signal which will be presented to the Power Amplifier 6 has been generated by combining all the carriers. This type of an implementation would be preferred for multi-band radio's or multi-band communication systems where generating all of the carriers from a single baseband unit is impractical due to the wide bandwidth. It could also find many application in satellite systems or VHF or UHF broadcast systems since they typically transmit a large number of carriers over a wide bandwidth. A multi-band subscriber terminal could also be a target application since the baseband of a handset is typically low cost and limited to a fairly modest bandwidth. As such, using two separate baseband sections and transmit chains, and combining the two carriers at RF could be a more cost effective solution. Once the two carriers are at RF, a low cost RFIC which performs the OBPPR could be used to reduce the Peak to Average Power Ratio of the multiband waveform prior to amplifying using a wideband power amplifier. This would allow a multiband handset to be developed which offers both low cost and a very competitive transmit power for a given PA size.

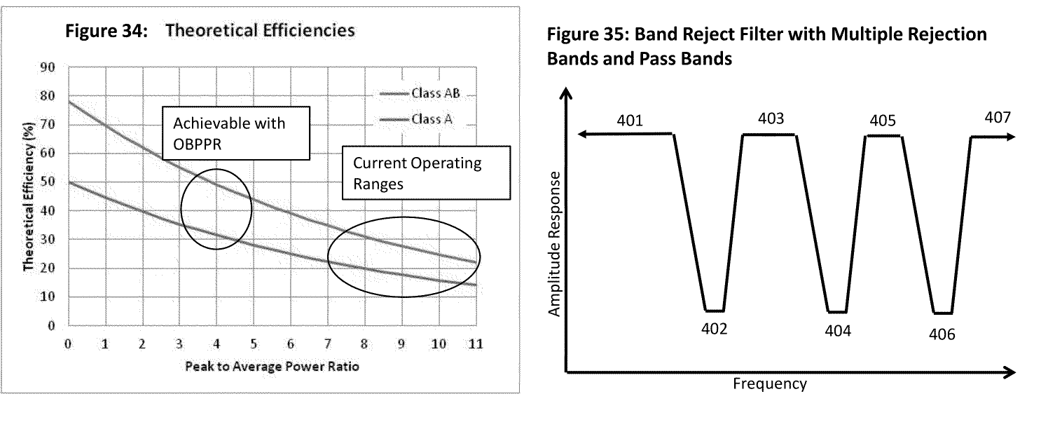

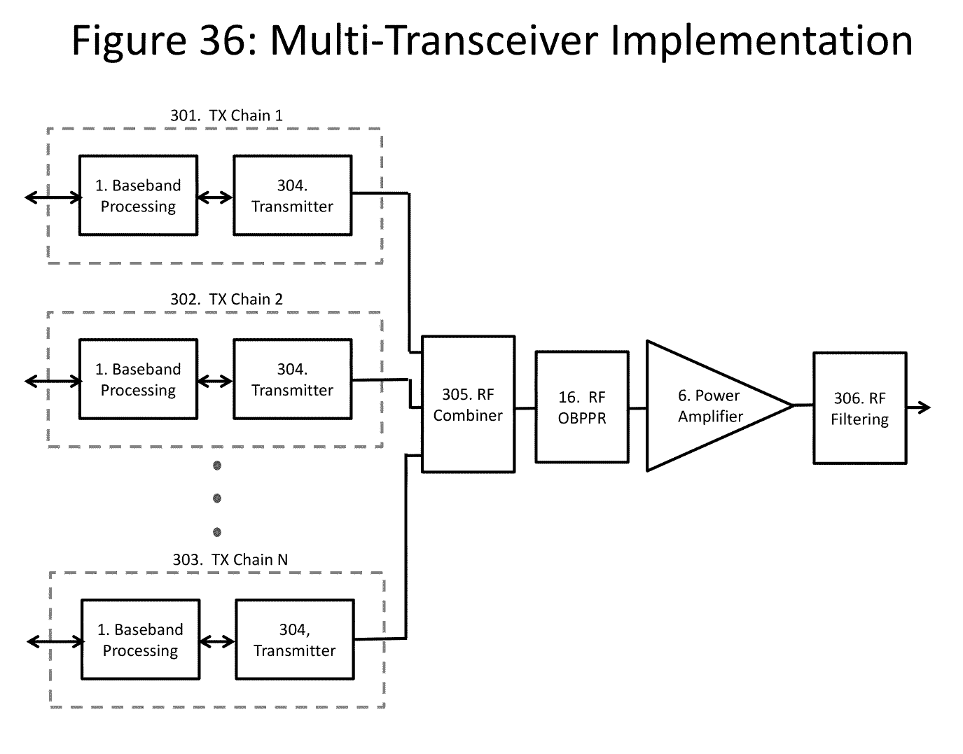

FIG. 34 provides an example of the improvements in Power Added Efficiency which can be achieved by lowering the Peak to Average Power Ratio using OBPPR. For Class AB amplifiers, the theoretical efficiency for PAPRs ranging from 11 dB to 7 dB is from 22% to 36%. By reducing the PAPR using an OBPPR signal to levels of 4.5 to 3.3 dB, the corresponding theoretical efficiencies for a Class AB amplifier become 46% to 55%, which is comparable to state of the art Doherty amplifiers. So a simple Class AB amplifier, when used in conjunction with Out of Band Peak Power Reduction, can achieve efficiencies which are comparable to much more complex state of the art Doherty amplifiers. If Out of Band Peak Power Reduction is used in conjunction with Doherty Amplifiers, then even better efficiencies could be achieved. Given that the PAPR is less than 6 dB, designing an Asymmetric Doherty Amplifier where the size of the Peaking Amplifier or amplifiers is smaller than the Main Amplifier, would provide optimal efficiencies.

It should also be mentioned that it would be possible to modify the algorithm to have portions of the peak power reduction signal be in-band or even in channel, so long as the power of this signal is sufficiently low so as not to cause the radio transmitter to fail regulatory specifications, adjacent or alternate channel emissions, or EVM requirements. To accomplish this the OBPPR signal could undergo different levels of filtering, to allow some power within the RF band, but not so much power that the transmitter fails its regulatory specifications. Furthermore, the algorithm could be modified to protect certain RF bands such as the Receive band, in the case of an FDD radio, or other bands which are sensitive to interference, by preventing the OBPPR signal from having energy at frequencies which coincides with these bands.

It should be clearly understood that the examples provided in this application have focused on wireless base stations or handsets and we have referred to the Radio Frequency (RF) as being the final frequency in the transmitter. However, the system could be used in other frequency bands to transmit AM broadcast signals or TV broadcast signals in the HF, VHF and UHF bands. The system could also be used at Micro-Wave or mm-Wave frequencies or any other frequencies where a signal needs to be transmitted. In this application we have used RF frequency to refer to the frequency at which the communication signal is to be transmitted over the airwave in the case of a wireless system, or over a cable in the case of wireline systems. Furthermore, the OBPPR methods described here could find applications in TV Broadcast station, Radio Broadcast stations, Wireless Backhaul applications, Satellite Uplink Transmissions, Satellite Downlink Transmissions, Cable TV transmitters, DSL transmitters or any other type of system where it is benefitial to reduce the peak to average power ratio of a communication signal.

### INDUSTRIAL APPLICABILITY

A method, system and apparatus are provided for effecting peak power reduction of a communication signal. In particular, the method achieves peak power reduction by generating an out of band peak power reduction (OBPPR) signal, which reduces the peaks of the waveform. The OBPPR signal can be generated at baseband, IF or RF. The method can be implemented in the digital domain using FPGA, DSP or ASIC or can be implemented in the analog domain using discrete circuitry, RFIC's or MMIC's or multi-chip modules. The method does not introduce significant amounts of EVM or sacrifice any capacity and as such offers considerable advantages compared to current state of the art methods. Furthermore, the method can be combined and is approximately additive with existing Peak Power Reduction Methods to effect greater levels of peak power reduction. The inventor has demonstrated a system which takes a WiMax waveform with a PAPR of 7.16 dB as an input, and produces an output waveform with a PAPR of 4.5 dB, while introducing very negligible amounts of EVM. The inventor has also demonstrated a multi-carrier OFDM transmitter as well as a Multi-Carrier GSM transmitter with 8 carriers, where the OBPPR signal was able to reduce the Peak to Average Power Ratio of the waveform from 9 dB to 2.8 dB and from 9.5 dB to 4.2 dB respectively. The systems, methods and apparatus described in this patent application will find use in Cellular Base Stations, CPE's, Satellite Communication systems, Microwave radio links, UHF and VHF broadcast and communication systems, backhaul systems, DSL systems, Cable modem systems and any other system where a communication signal is being transmitted and can benefit from a lower peak to average power ratio. Furthermore, the systems can be implemented for wireless communication or wireline communication systems and can be used at any frequency where it is desirable to transmit one or more communication signals.

1. A method of reducing the peak to average power ratio of a communication signal which comprises of:
a. Clipping or compressing the communication signal to reduce the peaks of the waveform to arrive at a clipped communication signal;
b. Subtracting the original communication signal from the said first clipped communication signal to arrive at an unfiltered distortion signal;
c. Filtering the said unfiltered distortion signal to eliminate or reduce distortion at frequencies where it is undesirable to have distortion products, to arrive at a filtered distortion signal;
d. Recombining the said filtered distortion signal with the said communication signal with the appropriate phase, to arrive at a composite signal with a reduced peak to average power ratio where a portion of the peak power reduction has been achieved by components of the said composite signal which fall at frequencies outside of the said communication channel.

2. A method as described in claim 1 where a portion of the said filtered distortion signal occupies frequencies which fall outside of the communication channel to form an Out of Band Peak Power Reducing Signal.

3. A method as describe in claim 2 where a portion of the said Out of Band Peak Power Reducing Signal occupies frequencies which are rejected by the Transmit Filter or Duplexer such that they are not transmitted by the antenna.

4. A method as described in claim 3 where the peak to average power ratio of the said composite signal is further reduced by:
a) Clipping or compressing the said composite signal from the previous stage, to create a “distorted composite signal” with a reduced peak power;
b) Subtracting the said composite signal from the said distorted composite signal to arrive at a new distortion signal;
c) Filtering the said “distortion signal” to reduce distortion at frequencies where it is undesirable to have distortion products, to arrive at a new filtered distortion signal;
d) Combining the said composite signal with the said new out of band peak power reducing signal, with the appropriate phase, to arrive at a new composite signal with a reduced peak to average power ratio;
e) Returning to step a) and repeating the process until a composite signal with a desired peak to average power ratio has been achieved.

5. A method as described in claim 4 where the Out of Band Peak Power Reducing Signal and Composite Signal are generated by processing the communication signal at a baseband frequency or an intermediate frequency, in either the digital or analog domains.

6. A method as described in claim 5 where the Out of Band Peak Power Reducing Signal comprises of intermodulation products of the communication signal.

7. A method as described in claim 4 where the Out of Band Peak Power Reducing Signal and Composite Signal are generated by processing the communication signal at an RF frequency.

8. A method as described in claim 7 where the Out of Band Peak Power Reducing Signal comprises of the odd harmonics and or the odd order intermodulation products of the communication signal.

9. A method as described in claim 6 where the communication signal comprises of two or more carriers.

10. A method as described in claim 9 where two or more of the carriers are non-adjacent.

11. A method as described in claim 10 where two or more of the carriers are being transmitted in a different frequency band.

12. A method of reducing the peak to average power ratio of a communication signal at an RF frequency which comprises of one or more RF carriers by:
a) Clipping or compressing the said communication signal to reduce the peaks of the waveform to arrive at a clipped communication signal which includes the intermodulation products as well as the harmonics of the one or more said RF Carriers;
b) Filtering the said clipped communication signal to remove distortion products that fall at undesirable frequencies such as on or around one or more of the said RF carriers to arrive at an Out of Band Peak Power Reducing Signal;
c) Combining the said communication signal with the said Out of Band Peak Power Reducing Signal with the appropriate phase, to arrive at a Composite Signal with a reduce peak to average power ratio.

13. A method as described in claim 12 where the peak to average power ratio of the said Composite Signal is reduced by signal components at the odd harmonics of the one or more RF carriers and or at the odd order intermodulation products of the one or more RF carriers.

14. A method as described in claim 13 where the peak to average power ratio of the said composite signal is further reduced by:
a) Clipping or compressing the said composite signal from the previous stage, to create a “distorted composite signal” with a reduced peak power;
b) Subtracting the said composite signal from the said distorted composite signal to arrive at a new distortion signal;
c) Filtering the said “distortion signal” to reduce distortion at frequencies where it is undesirable to have distortion products, to arrive at a new filtered distortion signal;
d) Combining the said composite signal with the said new out of band peak power reducing signal, with the appropriate phase, to arrive at a new composite signal with a reduced peak to average power ratio;
e) Returning to step a) and repeating the process until a composite signal with a desired peak to average power ratio has been achieved.

15. A method as described in claim 14 where the communication signal is first peak power reduced at a baseband or intermediate frequency to generate a first composite signal where the peak power reduction is achieved by components of the signal which comprise of the odd order intermodulation products of the said communication signal and then up converted to an RF frequency where it is further peak power reduced and where the peak power reduction is additionally achieved by components of the signal which comprise of the harmonics of the communication signal.

16. A system for transmitting a communication signal where the peak to average power ratio of said communication signal is reduced by generating an Out of Band Peak Power Reducing Signal which when added to the said communication signal reduces the peak power, and combining said Out of Band Peak Power Reducing Signal to the communication signal, with the appropriate phase, to arrive at a Composite Signal with a reduced peak power.
a) Clipping or compressing the said communication signal to reduce the peaks of the waveform to arrive at a clipped communication signal;
b) Filtering the said clipped communication signal to remove distortion products that fall at undesirable frequencies such as on or around one or more of the carriers to arrive at an Out of Band Peak Power Reducing Signal;
c) Combining the said communication signal with the said Out of Band Peak Power Reducing Signal with the appropriate phase, to arrive at a Composite Signal with a reduce peak to average power ratio.
d) Clipping or compressing the said composite signal from the previous stage, to create a new distorted composite signal with a reduced peak power;
e) Subtracting the said composite signal from the said new distorted composite signal to arrive at a new distortion signal;
f) Filtering the said new distortion signal to reduce distortion at frequencies where it is undesirable to have distortion products, to arrive at a new out of band peak power reducing signal;
g) Combining the said composite signal with the said new out of band peak power reducing signal, with the appropriate phase, to arrive at a new composite signal with a reduced peak to average power ratio;
h) Returning to step d) and repeating steps d, e, f and g until a composite signal with a desired peak to average power ratio has been achieved.

17. A system as described in claim 16 which comprises of a Baseband Processing Unit, a Transmit Chain a Power Amplifier and a Front End Filter.

18. A system as described in claim 17 where the Out of Band Peak Power Reducing Signal is generated in the said Baseband Signal Processing Unit.

19. A system as described in claim 17 where an RFIC, MMIC or Multi-Chip Module is used to generate an Out of Band Peak Power Reducing Signal after the carrier has been upconverted to an RF frequency.

20. A system as described in claim 17 where a first Out of Band Peak Power Reducing Signal is generated by the Baseband Processing Unit to arrive at a first Composite Signal with a reduced peak power, and a second Out of Band Peak Power Reducing Signal is generated by an RF circuit after the first Composite Signal has been up-converted to an RF frequency, to arrive at a second Composite Signal with a further reduction in Peak Power.

21. A system as described in claim 20 where a Front End Filter or Duplexer is used to filter a portion of the Out of Band Peak Power Reducing Signal after the Composite Signal has been amplified by the Power Amplifier such that it not be transmitted with the communication signal.

22. A system for transmitting a communication signal which comprises of two or more transmit chains to generate two or more communication signals at different RF frequencies and a combiner to combine the two or more carriers to arrive at a combined waveform where:
a) the peak to average power ratio of the combined waveform is reduced by generating an Out of Band Peak Power Reducing Signal which comprises of the odd order intermodulation products of the two or more carriers and or the odd order harmonics of the two or more carriers
b) Combining the said Out of Band Peak Power Reducing Signal to the said combined waveform, with the appropriate phase, to arrive at a composite signal with a reduced peak to average power ratio.
c) Amplifying the said composite waveform with a reduced peak to average power ratio with a single power amplifier.

23. A system as described in claim 22 where the two or more transmit chains operate to generate an RF carrier in at least 2 different RF bands.

24. A system as described in claim 23 where the Out of Band Peak Power Reducing Signal is generated and added to the communication signal by an analog RF circuit.

25. A system as described in claim 24 where the said RF circuit comprises of:
a) A Peak Power Reducing Stage which comprises of:
i) A circuit for performing a clipping function to reduce the peaks of the said communication signal and arrive at a Distorted Communication Signal.
ii) A Band Reject Filter for filtering off parts of the Distorted Communication Signal which coincide with frequencies which are occupied or near the communication signal to arrive at an Out of Band Peak Power Reducing signal.
iii) An All Pass Filter to provide a comparable amplitude and phase response as the pass band of the band reject filter.
iv) Combining the said communication signal and the Out of Band Peak Power Reducing signal to arrive at a Composite signal with a reduced peak power.

26. A system as described in claim 25 where the said RF circuit comprises of:
a) A Second Peak Power Reducing Stage which comprises of:
i) A circuit for performing a clipping function to reduce the peaks of the composite signal which was generated by the first Peak Power Reducing Stage, to arrive at a second Distorted Communication Signal.
ii) A 180 degree phase shifter to invert the phase of the Distorted Communication Signal.
iii) An All Pass Filter to provide a comparable amplitude and phase response as the said clipping function and 180 degree phase shifter.
iv) A combiner to combine the said Distorted Communication Signal and the Composite Communication Signal from the previous stage with the appropriate phase to arrive at a second Distortion Signal.
v) A second band reject filter to filter off parts of the second Distorted Communication Signal which coincide with frequencies which are occupied or near the communication signal to arrive at a Second Out of Band Peak Power Reducing signal.
vi) A second 180 degree phase shifter to invert the phase of the Second Out of Band Peak Power Reducing Signal.
v) A third all pass filter to delay the composite signal from the previous stage.
vi) Combining the Second Out of Band Peak Power Reducing Signal with the composite signal from the previous stage to arrive at a second composite signal with a reduced peak power.

27. A system as described in claim 4 which is further characterized by being a portion of a Wireless Base Station or Handset.

28. A system as described in claim 4 which is further characterized by being a portion of a satellite.

29. A system as described in claim 4 which is further characterized as being part of a wireless backhaul system.

30. A circuit for reducing the peak power of a communication signal at an RF frequency which comprises of one or more RF carriers by:
a) Clipping or compressing the said communication signal to reduce the peaks of the waveform to arrive at a clipped communication signal which includes the intermodulation products as well as the harmonics of the one or more said RF Carriers;
b) Filtering the said clipped communication signal to remove distortion products that fall at undesirable frequencies such as on or around one or more of the said RF carriers to arrive at an Out of Band Peak Power Reducing Signal;
c) Combining the said communication signal with the said Out of Band Peak Power Reducing Signal with the appropriate phase, to arrive at a Composite Signal with a reduced peak to average power ratio.

31. A circuit as claimed in 30 where a majority of the functionality is implemented in a digital signal process device such as an FPGA, ASIC or DSP chip.

32. A circuit as claimed in 30 where a majority of the functionality is implemented in an RFIC.

33. A circuit as claimed in 30 where a majority of the functionality is implemented in a Multi-Chip Module.

34. A circuit as in claim 33 where the band reject filters are implemented with one of a SAW filter or FBAR filter.
